(19) United States
(12) Patent Application Publication
(10) Pub. No.: US 2024/0314789 A1
(43) Pub. Date: Sep. 19, 2024

(54) DYNAMICALLY RECONFIGURABLE UPLINK RESOURCES

(71) Applicant: Telefonaktiebolaget LM Ericsson (publ), Stockholm (SE)

(72) Inventors: Ping Yu, Ottawa (CA); Annie Söderlund, Sollentuna (SE)

(21) Appl. No.: 18/576,917

(22) PCT Filed: Jul. 9, 2021
(86) PCT No.: PCT/IB2021/056199

§ 371 Date: Jan. 5, 2024

(51) Int. Cl. H04W 72/21; H04L 1/1829; H04W 72/1263

(52) U.S. Cl. CPC H04W 72/21; H04L 1/1854; H04W 72/1263

(57) ABSTRACT

Embodiments include methods for configuring uplink (UL) resources for a cell of a wireless network. Such methods include configuring each of a plurality of UL resources for the cell as one of the following: a static physical UL control channel (PUCCH) resource. a static physical UL shared channel (PUSCH) resource. or a dynamic resource. being initially configured as a PUSCH resource. Such methods include, when a number of UEs that are connected to the cell increases above a first threshold. reconfiguring one of the dynamic resources as a PUCCH resource according to a first PUCCH format. Such methods include. when a number of UEs connected to the cell that meet at least one criteria associated with downlink (DL) data increases above a second threshold, reconfiguring one of the dynamic resources as a PUCCH resource according to a second PUCCH format. Other embodiments include network nodes configured to perform such methods.

### TECHNICAL FIELD

The present invention generally relates to wireless communication networks, and more specifically to techniques whereby time/frequency resources used for uplink (UL, e.g., wireless device to network) transmission can be dynamically reconfigured according to various traffic requirements and/or conditions.

### BACKGROUND

Currently the fifth generation (“5G”) of cellular systems, also referred to as New Radio (NR), is being standardized within the Third-Generation Partnership Project (3GPP). NR is developed for maximum flexibility to support multiple and substantially different use cases. These include enhanced mobile broadband (eMBB), machine type communications (MTC), ultra-reliable low latency communications (URLLC), side-link device-to-device (D2D), and several other use cases. NR was initially specified in 3GPP Release 15 (Rel-15) and continues to evolve through subsequent releases, such as Rel-16 and Rel-17.

5G/NR technology shares many similarities with fourth-generation Long-Term Evolution (LTE). For example, NR uses CP-OFDM (Cyclic Prefix Orthogonal Frequency Division Multiplexing) in the downlink (DL) from network to user equipment (UE), and both CP-OFDM and DFT-spread OFDM (DFT-S-OFDM) in the uplink (UL) from UE to network. As another example, NR DL and UL time-domain physical resources are organized into equal-sized 1-ms subframes. A subframe is further divided into multiple slots of equal duration, with each slot including multiple OFDM-based symbols. However, time-frequency resources can be configured much more flexibly for an NR cell than for an LTE cell. For example, rather than a fixed 15-kHz OFDM sub-carrier spacing (SCS) as in LTE, NR SCS can range from 15 to 240 kHz, with even greater SCS considered for future NR releases.

In addition to providing coverage via cells as in LTE, NR networks also provide coverage via “beams.” In general, a downlink (DL, i.e., network to UE) “beam” is a coverage area of a network-transmitted reference signal (RS) that may be measured or monitored by a UE. In NR, for example, RS can include any of the following: synchronization signal/PBCH block (SSB), channel state information RS (CSI-RS), tertiary reference signals (or any other sync signal), positioning RS (PRS), demodulation RS (DMRS), phase-tracking reference signals (PTRS), etc. In general, SSB is available to all UEs regardless of the state of their connection with the network, while other RS (e.g., CSI-RS, DM-RS, PTRS) are associated with specific UEs that have a network connection.

FIG. 1 shows an exemplary configuration of NR user plane (UP) and control plane (CP) protocol stacks between a UE, a gNodeB (gNB, e.g., base station), and an access and mobility management function (AMF) in the 5G core network (5GC). Physical (PHY), Medium Access Control (MAC), Radio Link Control (RLC), and Packet Data Convergence Protocol (PDCP) layers between the UE and the gNB are common to UP and CP. The PDCP layer provides ciphering/deciphering, integrity protection, sequence numbering, reordering, and duplicate detection for CP and UP.

PDCP provides header compression and retransmission for UP data. On the UP side, Internet protocol (IP) packets arrive to the PDCP layer as service data units (SDUs), and PDCP creates protocol data units (PDUs) to deliver to RLC. In addition, the Service Data Adaptation Protocol (SDAP) layer handles quality-of-service (QOS) including mapping between QoS flows and Data Radio Bearers (DRBs) and marking QoS flow identifiers (QFI) in UL and DL packets.

When each IP packet arrives, PDCP starts a discard timer. When this timer expires, PDCP discards the associated SDU and the corresponding PDU. If the PDU was delivered to RLC, PDCP also indicates the discard to RLC. The RLC layer transfers PDCP PDUs to the MAC through logical channels (LCH). RLC provides error detection/correction, concatenation, segmentation/reassembly, sequence numbering, reordering of data transferred to/from the upper layers. If RLC receives a discard indication from associated with a PDCP PDU, it will discard the corresponding RLC SDU (or any segment thereof) if it has not been sent to lower layers.

The MAC layer provides mapping between LCHs and PHY transport channels, LCH prioritization, multiplexing into or demultiplexing from transport blocks (TBs), hybrid ARQ (HARQ) error correction, and dynamic scheduling (on gNB side). The PHY layer provides transport channel services to the MAC layer and handles transfer over the NR radio interface, e.g., via modulation, coding, antenna mapping, and beam forming.

On CP side, the non-access stratum (NAS) layer is between UE and AMF and handles UE/gNB authentication, mobility management, and security control. The RRC layer sits below NAS in the UE but terminates in the gNB rather than the AMF. RRC controls communications between UE and gNB at the radio interface as well as the mobility of a UE between cells in the NG-RAN. RRC also broadcasts system information (SI) and establishes, configures, maintains, and releases DRBs and Signaling Radio Bearers (SRBs) used by UEs. Additionally, RRC controls addition, modification, and release of carrier aggregation (CA) and dual-connectivity (DC) configurations for UEs. RRC also performs various security functions such as key management.

After a UE is powered ON it will be in the RRC_IDLE state until an RRC connection is established with the network, at which time the UE will transition to RRC_CONNECTED state (e.g., where data transfer can occur). The UE initiates connection establishment by transmitting a random access preamble on a physical random access channel (PRACH). The UE returns to RRC_IDLE after the connection with the network is released. In RRC_IDLE state, the UE's radio is active on a discontinuous reception (DRX) schedule configured by upper layers. During DRX active periods (also referred to as “DRX On durations”), an RRC_IDLE UE receives SI broadcast in the cell where the UE is camping. performs measurements of neighbor cells to support cell reselection, and monitors a paging channel on physical DL control channel (PDCCH) for pages from 5GC via gNB.

NR UL and DL data transmissions take place on physical UL shared channel (PUSCH) and physical DL shared channel (PDSCH), respectively. In either case, the entity receiving the data (i.e., UE for PDSCH, gNB for PUSCH) responds with hybrid ARQ feedback indicating correct reception by a positive acknowledgement (ACK) or incorrect reception by a negative acknowledgement (NACK).

PDSCH and PUSCH data transmissions can take place with or without an explicit grant or assignment of resources by the network (e.g., gNB). In general, UL transmissions are usually referred to as being “granted” by the network (i.e., “UL grant”), while DL transmissions are usually referred to as being “assigned” by the network (i.e., “DL assignment”). For a transmission based on an explicit grant/assignment, the gNB sends DL control information (DCI) to a UE informing it of specific resources to be used for the transmission. The gNB scheduler issues the grant/assignment based on knowledge of DL data in the gNB buffer or UL data in the UE buffer, which the UE reports via buffer status report (BSR) and/or a one-bit scheduling request (SR).

In contrast, a transmission without an explicit grant/assignment is typically configured with a defined periodicity. Given a periodic and/or recurring UL grant and/or DL assignment, the UE can then initiate a data transmission and/or receive data according to a predefined configuration. Such transmissions can be referred to as semi-persistent scheduling (SPS, for DL), configured grant (CG, for UL), or grant-free transmissions.

UEs transmit HARQ feedback and SRs via a physical UL control channel (PUCCH). Additionally, a gNB periodically transmits DL channel state information reference signals (CSI-RS) from which a UE estimates the DL channel. UEs also report this CSI feedback to the gNB via PUCCH or PUSCH. Similarly, UEs can send BSRs via PUCCH or PUSCH. There are various PUCCH formats (PF) that can be used for sending various amounts of UL data.

Each cell in an NR network will have a set of UL time/frequency resources that must be partitioned among various UL channels including PUCCH, PUSCH, and PRACH. Additionally, the network must partition the PUCCH resources among the various PFs in use. This partitioning is conventionally done at cell setup based on maximum expected values of various traffic metrics. However, the initial partitioning may be inadequate as actual cell traffic conditions change.

### SUMMARY

Embodiments of the present disclosure provide specific improvements to UL resource partitioning in cells of a wireless network, such as by providing, enabling, and/or facilitating more flexible and/or dynamic techniques to overcome exemplary problems summarized above and described in more detail below.

Embodiments include methods (e.g., procedures) for configuring uplink (UL) resources for a cell of a wireless network. These exemplary methods can be performed by a network node (e.g., base station, gNB, ng-eNB, etc. or components thereof) in the wireless network (e.g., NG-RAN, E-UTRAN).

These exemplary methods can include configuring each of a plurality of UL resources for the cell as one of the following: a static physical UL control channel (PUCCH) resource, a static physical UL shared channel (PUSCH) resource, or a dynamic resource, being initially configured as a PUSCH resource. These exemplary methods can also include, when a number of UEs that are connected to the cell increases above a first threshold, reconfiguring one of the dynamic resources as a PUCCH resource according to a first PUCCH format. These exemplary methods can also include, when a number of UEs connected to the cell that meet at least one criteria associated with downlink (DL) data increases above a second threshold, reconfiguring one of the dynamic resources as a PUCCH resource according to a second PUCCH format.

In some embodiments, each of the plurality of UL resources for the cell is a physical resource block (PRB). In some embodiments, the first PUCCH format is PUCCH Format 1 (PF1) and the second PUCCH format is either PUCCH Format 3 (PF3) or PUCCH Format 4 (PF4), as specified by 3GPP. In some embodiments, the at least one criteria associated with DL data includes one or more of the following: operating in CA with pending DL data; and receiving DL data over the same time resources and/or the same frequency resources via spatial multiplexing. In some embodiments, the UL resources for the cell can also include static PRACH resources.

In some embodiments, a first subset of the dynamic resources can have either the first PUCCH format or the second PUCCH format, while a second subset of the dynamic resources can have the second PUCCH format but not the first PUCCH format. In some of these embodiments, the first subset is adjacent in frequency to static PUCCH resources.

In some embodiments, these exemplary methods can also include, when the number of UEs connected to the cell decreases below a third threshold, reconfiguring one of the dynamic resources from the first PUCCH format to the second PUCCH format. In some of these embodiments, reconfiguring one of the dynamic resources from the first PUCCH format to the second PUCCH format can be further based on the number of UEs connected to the cell that meet the at least one criteria being above a fourth threshold. In such embodiments, these exemplary methods can also include, when the number of UEs connected to the cell that meet the at least one criteria is below the fourth threshold, reducing the dynamic resources configured according to the first PUCCH format and increasing the dynamic resources configured as PUSCH resources.

In some variants, reducing the dynamic resources configured according to the first PUCCH format and increasing the dynamic resources configured as PUSCH resources can include reconfiguring one of the dynamic resources from the first PUCCH format to a PUSCH resource.

In other variants, reducing the dynamic resources configured according to the first PUCCH format and increasing the dynamic resources configured as PUSCH resources can include reconfiguring a first one of the dynamic resources from the second PUCCH format to a PUSCH resource and reconfiguring a second one of the dynamic resources from the first PUCCH format to the second PUCCH format. For example, the first one of the dynamic resources is adjacent in frequency to a static PUSCH resource and the second one of the dynamic resources is not adjacent in frequency to any of the static PUSCH resources.

In some embodiments, these exemplary methods can also include, when the number of users connected to the cell increases above a fifth threshold, reconfiguring one of the dynamic resources from the second PUCCH format to the first PUCCH format. In some of these embodiments, the dynamic resource reconfigured from the second PUCCH format to the first PUCCH format can be adjacent in frequency to a static PUCCH resource.

In some of these embodiments, reconfiguring one of the dynamic resources from the second PUCCH format to the first PUCCH format can include: determining a last timeslot allocated for hybrid ARQ (HARQ) feedback in the dynamic resource to be reconfigured; determining a schedule for the HARQ feedback and scheduling requests (SR) to be carried by the dynamic resource after reconfiguration; and determining an updated PRI for transmission with DL resource grants after the last timeslot according to the determined schedule. The updated PRI identifies the dynamic resources configured as PUCCH resources according to the second PUCCH format, including the dynamic resource to be reconfigured.

In some embodiments, these exemplary methods can also include, when the number of UEs connected to the cell that meet the at least one criteria decreases below a sixth threshold, reconfiguring one of the dynamic resources from the second PUCCH format to a PUSCH resource. In some of these embodiments, these reconfiguring operations can include determining a last timeslot allocated for hybrid ARQ (HARQ) feedback in the dynamic resource to be reconfigured and determining an updated PRI for transmission with DL resource grants after the last timeslot. The updated PRI identifies the dynamic resources configured as PUCCH resources according to one of the first PUCCH format and the second PUCCH format, excluding the dynamic resource to be reconfigured.

In some embodiments, these exemplary methods can also include transmitting one or more DL resource grants to UEs operating in the cell, wherein each DL resource grant includes a PRI that identifies at least part of the static PUCCH resources and at least part of the dynamic resources configured as PUCCH resources. In some of these embodiments, each transmitted PRI identifies one of the following:
portions of the static PUCCH resources and the dynamic resources that are configured according to the first PUCCH format; or
portions of the static PUCCH resources and the dynamic resources that are configured according to the second PUCCH format.

Other embodiments include network nodes (e.g., base stations, gNBs, ng-eNBs, etc., or components thereof) configured to perform operations corresponding to any of the exemplary methods described herein. Other embodiments include non-transitory, computer-readable media storing program instructions that, when executed by processing circuitry, configure such network nodes to perform operations corresponding to any of the exemplary methods described herein.

These and other disclosed embodiments provide flexible and efficient techniques whereby UL resources can be dynamically reassigned to PUSCH or PUCCH and/or reconfigured to a different PUCCH format based on currently prevailing traffic conditions in a cell. Based on flexible reconfiguration of dynamic UL resources, the available UL resources in a cell can be used more effectively based on actual capacity and traffic needs at any given time. This can reduce the amount of UL resources that are unusable in various traffic conditions, which increases cell capacity both in terms of number of supported users and amount of UL/DL data traffic. Moreover, embodiments can reduce complexity of initial cell planning and optimization since they facilitate dynamic re-optimization of UL resources according to prevailing needs.

These and other objects, features, and advantages of embodiments of the present disclosure will become apparent upon reading the following Detailed Description in view of the Drawings briefly described below.

### BRIEF DESCRIPTION OF THE DRAWINGS

FIG. 1 shows an exemplary NR user plane (UP) and control plane (CP) protocol stacks.

FIG. 2 illustrates a high-level views of an exemplary 5G/NR network architecture.

FIG. 3 shows an exemplary frequency-domain configuration for an NR user equipment (UE).

FIG. 4 shows an exemplary time-frequency resource grid for an NR slot.

FIG. 5 shows an exemplary arrangement of control and data channels within an NR slot.

FIG. 6 shows two exemplary arrangements of uplink (UL) resources for a cell, according to conventional techniques.

FIG. 7 shows two exemplary arrangements of UL resources for a cell, according to various embodiments of the present disclosure.

FIG. 8 shows an exemplary state transition diagram for a dynamic UL resource, according to various embodiments of the present disclosure.

FIGS. 9-12 show exemplary timing diagrams for transitions of a dynamic UL resource between various configurations, according to various embodiments of the present disclosure.

FIGS. 13A-B show a flow diagram of an exemplary method (e.g., procedure) for configuring UL resources for a cell of a wireless network, according to various embodiments of the present disclosure.

FIG. 14 shows a communication system according to various embodiments of the present disclosure.

FIG. 15 shows a UE according to various embodiments of the present disclosure.

FIG. 16 shows a network node according to various embodiments of the present disclosure.

FIG. 17 shows host computing system according to various embodiments of the present disclosure.

FIG. 18 is a block diagram of a virtualization environment in which functions implemented by some embodiments of the present disclosure may be virtualized.

FIG. 19 illustrates communication between a host computing system, a network node, and a UE via multiple connections, at least one of which is wireless, according to various embodiments of the present disclosure.

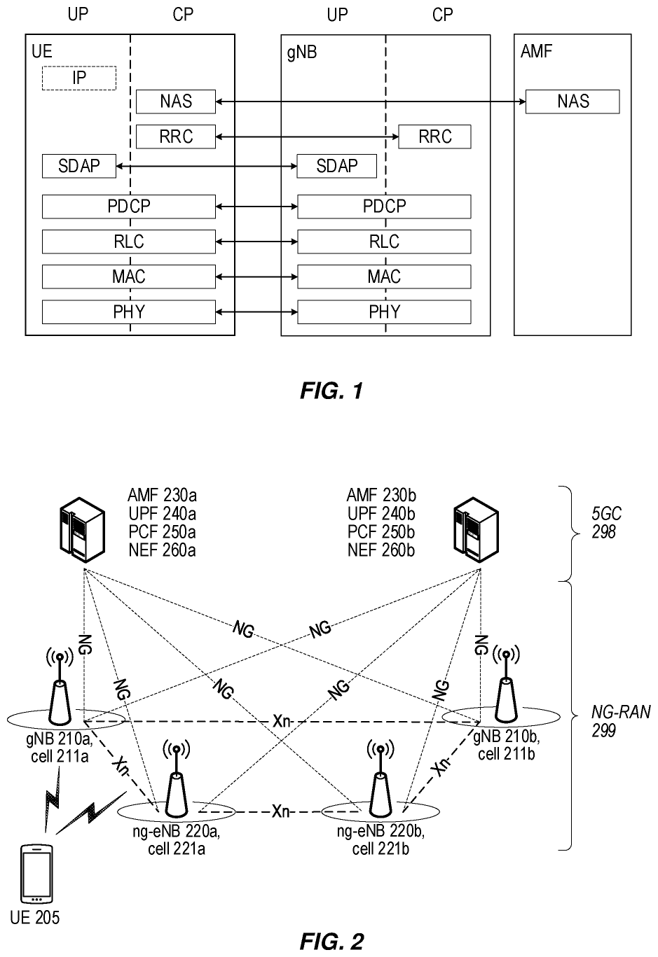

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where a step must necessarily follow or precede another step due to some dependency. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Furthermore, the following terms are used throughout the description given below:
Radio Node: As used herein, a “radio node” can be either a radio access node or a wireless device.”
Node: As used herein, a “node” can be a network node or a wireless device.
Radio Access Node: As used herein, a “radio access node” (or equivalently “radio network node,” “radio access network node,” or “RAN node”) can be any node in a radio access network (RAN) of a cellular communications network that operates to wirelessly transmit and/or receive signals. Some examples of a radio access node include, but are not limited to, a base station (e.g., a New Radio (NR) base station (gNB) in a 3GPP Fifth Generation (5G) NR network or an enhanced or evolved Node B (eNB) in a 3GPP LTE network), base station distributed components (e.g., CU and DU), a high-power or macro base station, a low-power base station (e.g., micro, pico, femto, or home base station, or the like), an integrated access backhaul (IAB) node, a transmission point, a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a Packet Data Network Gateway (P-GW), an access and mobility management function (AMF), a session management function (AMF), a user plane function (UPF), a Service Capability Exposure Function (SCEF), or the like.
Wireless Device: As used herein, a “wireless device” (or “WD” for short) is any type of device that has access to (i.e., is served by) a cellular communications network by communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Some examples of a wireless device include, but are not limited to, smart phones, mobile phones, cell phones, voice over IP (VOIP) phones, wireless local loop phones, desktop computers, personal digital assistants (PDAs), wireless cameras, gaming consoles or devices, music storage devices, playback appliances, wearable devices, wireless endpoints, mobile stations, tablets, laptops, laptop-embedded equipment (LEE), laptop-mounted equipment (LME), smart devices, wireless customer-premise equipment (CPE), mobile-type communication (MTC) devices, Internet-of-Things (IoT) devices, vehicle-mounted wireless terminal devices, etc. Unless otherwise noted, the term “wireless device” is used interchangeably herein with the term “user equipment” (or “UE” for short).
Network Node: As used herein, a “network node” is any node that is either part of the radio access network (e.g., a radio access node or equivalent name discussed above) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.

Note that the description herein focuses on a 3GPP cellular communications system and, as such, 3GPP terminology or terminology similar to 3GPP terminology is oftentimes used. However, the concepts disclosed herein are not limited to a 3GPP system. Furthermore, although the term “cell” is used herein, it should be understood that (particularly with respect to 5G NR) beams may be used instead of cells and, as such, concepts described herein apply equally to both cells and beams.

FIG. 2 shows a high-level view of an exemplary 5G network architecture, including a Next Generation Radio Access Network (NG-RAN) 299 and a 5G Core (5GC) 298. As shown in the figure, NG-RAN 299 can include gNBs 210 (e.g., 210a,b) and ng-eNBs 220 (e.g., 220a,b) that are interconnected with each other via respective Xn interfaces. The gNBs and ng-eNBs are also connected via the NG interfaces to 5GC 298, more specifically to the AMF (Access and Mobility Management Function) 230 (e.g., AMFs 230a,b) via respective NG-C interfaces and to the UPF (User Plane Function) 240 (e.g., UPFs 240a,b) via respective NG-U interfaces. Moreover, the AMFs 230a,b can communicate with one or more policy control functions (PCFs, e.g., PCFs 250a,b) and network exposure functions (NEFs, e.g., NEFs 260a,b).

Each of the gNBs 210 can support the NR radio interface including frequency division duplexing (FDD), time division duplexing (TDD), or a combination thereof. In contrast, each of ng-eNBs 220 can support the LTE radio interface but, unlike conventional LTE eNodeBs (eNBs), connect to the 5GC via the NG interface. Each of the gNBs and ng-eNBs can serve a geographic coverage area including one more cells, including cells 211a-b and 221a-b shown as exemplary in FIG. 2. The gNBs and ng-eNBs can also use various directional beams to provide coverage in the respective cells. Depending on the particular cell in which it is located, a UE 205 can communicate with the gNB or ng-eNB serving that cell via the NR or LTE radio interface, respectively.

The gNBs shown in FIG. 2 can include a central (or centralized) unit (CU or gNB-CU) and one or more distributed (or decentralized) units (DU or gNB-DU), which can be viewed as logical nodes. CUs host higher-layer protocols and perform various gNB functions such controlling the operation of DUs, which host lower-layer protocols and can include various subsets of the gNB functions. As such, each of the CUs and DUs can include various circuitry needed to perform their respective functions, including processing circuitry, communication interface circuitry (e.g., for communication via Xn, NG, radio, etc. interfaces), and power supply circuitry. Moreover, the terms “central unit” and “centralized unit” can be used interchangeably, as can the terms “distributed unit” and “decentralized unit.”

A CU connects to its associated DUs over respective F1 logical interfaces. A CU and associated DUs are only visible to other gNBs and the 5GC as a gNB, e.g., the F1 interface is not visible beyond a CU. A CU can host higher-layer protocols such as F1 application part protocol (F1-AP), Stream Control Transmission Protocol (SCTP), GPRS Tunneling Protocol (GTP), Packet Data Convergence Protocol (PDCP), User Datagram Protocol (UDP), Internet Protocol (IP), and Radio Resource Control (RRC) protocol. In contrast, a DU can host lower-layer protocols such as Radio Link Control (RLC), Medium Access Control (MAC), and physical-layer (PHY) protocols.

Other variants of protocol distributions between CU and DU can exist, however, such as hosting the RRC, PDCP and part of the RLC protocol in the CU (e.g., Automatic Retransmission Request (ARQ) function), while hosting the remaining parts of the RLC protocol in the DU, together with MAC and PHY. In some embodiments, the CU can host RRC and PDCP, where PDCP is assumed to handle both UP traffic and CP traffic. Nevertheless, other exemplary embodiments may utilize other protocol splits that by hosting certain protocols in the CU and certain others in the DU.

NR DL and UL physical resources are organized into equal-sized 1-ms subframes. A subframe is further divided into multiple slots of equal duration, with each slot including multiple OFDM-based symbols. An NR slot can include 14 OFDM symbols for normal cyclic prefix and 12 symbols for extended cyclic prefix. A resource block (RB) consists of a group of 12 contiguous OFDM subcarriers for a duration of a 12- or 14-symbol slot. A resource element (RE) corresponds to one OFDM subcarrier during one OFDM symbol interval.

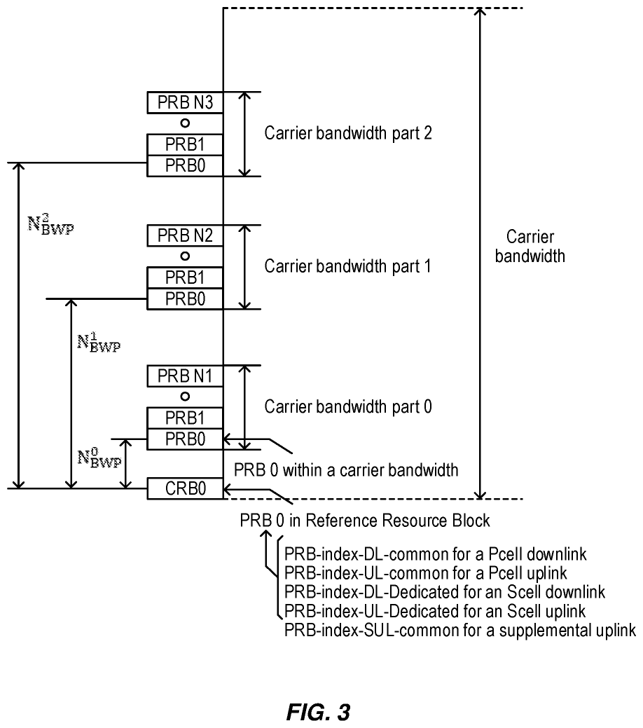

FIG. 3 shows an exemplary frequency-domain configuration for an NR UE. In Rel-15 NR, a UE can be configured with up to four carrier bandwidth parts (BWPs) in a DL carrier bandwidth with a single DL BWP being active at a given time. A UE can be configured with up to four BWPs in an UL carrier bandwidth with a single UL BWP being active at a given time. If a UE is configured with a supplementary UL, the UE can be configured with up to four additional BWPs in the supplementary UL carrier bandwidth, with a single supplementary UL BWP being active at a given time.

Common RBs (CRBs) are numbered from 0 to the end of the carrier bandwidth. Each BWP configured for a UE has a common reference of CRBO, such that a configured BWP may start at a CRB greater than zero. CRBO can be identified by one of the following parameters provided by the network, as further defined in 3GPP TS 38.211 section 4.4:
PRB-index-DL-common for DL in a primary cell (PCell, e.g., PCell or PSCell);
PRB-index-UL-common for UL in a PCell;
PRB-index-DL-Dedicated for DL in a secondary cell (SCell);
PRB-index-UL-Dedicated for UL in an SCell; and
PRB-index-SUL-common for a supplementary UL.

In this manner, a UE can be configured with a narrow BWP (e.g., 10 MHz) and a wide BWP (e.g., 100 MHz), each starting at a particular CRB, but only one BWP can be active for the UE at a given point in time. PRBs within a BWP are numbered in the frequency domain from 0 to V_{BWPi}^{size}−1, where i is index of the particular BWP for the carrier. In the example of FIG. 3, BWP0 includes PRBs 0-N1, BWP1 includes PRBs 0-N2, and BWP2 includes PRBs 0-N3.

NR supports various SCS values Δf=(15×2^{μ}) kHz, where μ∈(0,1,2,3,4) are referred to as “numerologies.” Numerology μ=0 (i.e., Δ=15 kHz) provides the basic (or reference) SCS that is also used in LTE. The symbol duration, cyclic prefix (CP) duration, and slot duration are inversely related to SCS or numerology. For example, there is one (1-ms) slot per subframe for Δf=15 kHz, two 0.5-ms slots per subframe for Δf=30 kHz, etc. In addition, the maximum carrier bandwidth is directly related to numerology according to 2^{μ}·50 MHz. Table 1 below summarizes currently-supported NR numerologies and associated parameters. Different DL and UL numerologies can be configured by the network.

TABLE 1

| | Δf = 2^{μ} · | Cyclic | CP | Symbol | Symbol + | Slot | | Max carrier |
|---|---|---|---|---|---|---|---|---|
| μ | 15 (kHz) | prefix (CP) | duration | duration | CP | duration | | BW |
| 0 | 15 | Normal | 4.69 μs | 66.67 μs | 71.35 μs | 1 | ms | 50 MHz |
| 1 | 30 | Normal | 2.34 μs | 33.33 μs | 35.68 μs | 0.5 | ms | 100 MHz |
| 2 | 60 | Normal, | 1.17 μs | 16.67 μs | 17.84 μs | 0.25 | ms | 200 MHz |
| | | Extended | | | | | | |
| 3 | 120 | Normal | 0.59 μs | 8.33 μs | 8.92 μs | 125 | μs | 400 MHz |
| 4 | 240 | Normal | 0.29 μs | 4.17 μs | 4.46 μs | 62.5 | μs | 800 MHz |

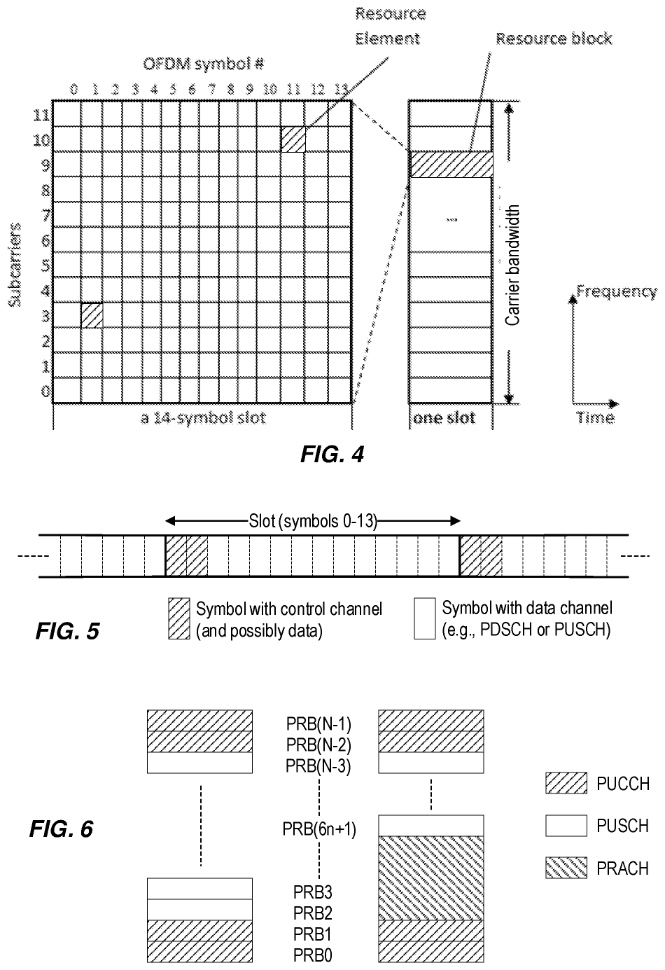

FIG. 4 shows an exemplary time-frequency resource grid for an NR slot within a carrier bandwidth. As illustrated in FIG. 4, a resource block (RB) consists of a group of 12 contiguous OFDM subcarriers for a duration of a 14-symbol slot. Like in LTE, a resource element (RE) consists of one subcarrier in one slot. An NR slot can include 14 OFDM symbols for normal cyclic prefix (e.g., as shown in FIG. 4) and 12 symbols for extended cyclic prefix.

In addition, NR includes Type-B scheduling, also known as “mini-slots.” These are shorter than slots, typically ranging from one symbol up to one less than the number of symbols in a slot (e.g., 13 or 11), and can start at any symbol of a slot. Mini-slots can be used if the transmission duration of a slot is too long and/or the occurrence of the next slot start (slot alignment) is too late. Mini-slots can be used for unlicensed spectrum and latency-critical transmissions (e.g., URLLC). However, mini-slots are not service-specific and can also be used for eMBB or other services.

An NR slot can also be arranged with various time-division duplexing (TDD) arrangements of UL and DL symbols. These TDD arrangements include:
DL-only (i.e., no UL transmission) slot with transmission late-start in symbol 1;
DL-heavy, with one UL symbol and guard periods before and after the UL symbol to facilitate change of transmission direction;
UL-heavy, with a single UL symbol that can carry DL control information;
UL-only with transmission on-time start in symbol 0 and the initial UL symbol usable to carry DL control information; and
DL symbol followed by an UL symbol with an intermediate guard period (referred to as “special slots”).

FIG. 5 shows another exemplary NR slot structure comprising 14 symbols. In this arrangement, PDCCH is confined to a region containing a particular number of symbols and a particular number of subcarriers, referred to as the control resource set (CORESET). In the exemplary structure shown in FIG. 5, the first two symbols contain PDCCH and each of the remaining 12 symbols contains physical data channels (PDCH), i.e., either PDSCH or PUSCH. Depending on the particular CORESET configuration (discussed below), however, the first two slots can also carry PDSCH or other information, as required.

A CORESET includes multiple RBs (i.e., multiples of 12 REs) in the frequency domain and 1-3 OFDM symbols in the time domain. The frequency bandwidth of the CORESET is variable. CORESET resources can be indicated to a UE by RRC signaling. The smallest unit used for defining CORESET is the REG, which spans one PRB in frequency and one OFDM symbol in time. In addition to PDCCH, each REG contains demodulation reference signals (DM-RS) to aid in the estimation of the radio channel over which that REG was transmitted. To assist a UE with channel estimation, multiple REGs can be grouped together to form a REG bundle, and the REG bundle size (i.e., 2, 3, or 5 REGs) can be indicated to the UE. The UE can assume that any precoder used for transmission of PDCCH is the same over an entire REG bundle.

An NR control channel element (CCE) consists of six REGs. These REGs may either be contiguous or distributed in frequency. When the REGs are distributed in frequency, the CORESET is said to use interleaved mapping of REGs to a CCE, while if the REGs are contiguous in frequency, a non-interleaved mapping is said to be used. Interleaving can provide frequency diversity. Not using interleaving is beneficial for cases where knowledge of the channel allows the use of a precoder in a particular part of the spectrum improve the SINR at the receiver.

As mentioned above, NR data scheduling can be performed dynamically, e.g., on a per-slot basis. In each slot, the gNB transmits downlink control information (DCI) over PDCCH that indicates which UE is scheduled to receive data in that slot, as well as which RBs will carry that data. A UE first detects and decodes DCI and, if the DCI includes DL scheduling information for the UE, receives the corresponding PDSCH based on the DL scheduling information. DCI formats 1_0 and 1_1 are used to convey PDSCH scheduling.

Likewise, DCI on PDCCH can include UL grants that indicate which UE is scheduled to transmit data on PUCCH in that slot, as well as which RBs will carry that data. A UE first detects and decodes DCI and, if the DCI includes an uplink grant for the UE, transmits the corresponding PUSCH on the resources indicated by the UL grant. DCI formats 0_0 and 0_1 are used to convey UL grants for PUSCH, while Other DCI formats (2_0, 2_1, 2_2 and 2_3) are used for other purposes including transmission of slot format information, reserved resource, transmit power control information, etc.

A DCI includes a payload complemented with a Cyclic Redundancy Check (CRC) of the payload data. Since DCI is sent on PDCCH that is received by multiple UEs, an identifier of the targeted UE needs to be included. In NR, this is done by scrambling the CRC with a Radio Network Temporary Identifier (RNTI) assigned to the UE. Most commonly, the cell RNTI (C-RNTI) assigned to the targeted UE by the serving cell is used for this purpose.

DCI payload together with an identifier-scrambled CRC is encoded and transmitted on the PDCCH. Given previously configured search spaces, each UE tries to detect a PDCCH addressed to it according to multiple hypotheses (also referred to as “candidates”) in a process known as “blind decoding.” PDCCH candidates span 1, 2, 4, 8, or 16 CCEs, with the number of CCEs referred to as the aggregation level (AL) of the PDCCH candidate. If more than one CCE is used, the information in the first CCE is repeated in the other CCEs. By varying AL, PDCCH can be made more or less robust for a certain payload size. In other words, PDCCH link adaptation can be performed by adjusting AL. Depending on AL, PDCCH candidates can be located at various time-frequency locations in the CORESET.

Once a UE decodes a DCI, it de-scrambles the CRC with RNTI(s) that is(are) assigned to it and/or associated with the particular PDCCH search space. In case of a match, the UE considers the detected DCI as being addressed to it, and follows the instructions (e.g., scheduling information) in the DCI.

For example, to determine the modulation order, target code rate, and TB size(s) for a scheduled PDSCH transmission, the UE first reads the five-bit modulation and coding scheme field (IMCs) in the DCI (e.g., formats 1_0 or 1_1) to determine the modulation order (Qm) and target code rate (R) based on the procedure defined in 3GPP TS 38.214 (v15.0.0) clause 5.1.3.1. Subsequently, the UE reads the redundancy version field (rv) in the DCI to determine the redundancy version. Based on this information, the number of layers (v), and the total number of allocated PRBs before rate matching (NPRB), the UE determines the Transport Block Size (TBS) for the PDSCH according to the procedure defined in 3GPP TS 38.214 (v15.0.0) clause 5.1.3.2.

In summary, dynamic scheduling provides a single grant or assignment of resources (i.e., via DCI) to individual devices for an upcoming transmit time interval (TTI, e.g., slot). The grant or assignment tells UEs when and what transport format to use for an upcoming data transmission.

The scheduler issues UL resource grants based on knowledge of data stored in UE buffers via buffer status reports (BSRs). UEs may send BSRs using already-granted UL resources, or may send a one-bit scheduling request (SR) on PUCCH shared resources to request a grant of UL resources for BSR. The gNB may grant UL resources in response to the SR and may grant additional UL resources in response to the BSR.

Each cell in an NR network will have a set of UL time/frequency resources (e.g., PRBs such as illustrated by FIG. 4) that must be partitioned among various UL channels including PUCCH, PUSCH, and PRACH. Additionally, the network must partition the PUCCH resources among the various PFs in use. Table 2 below shows various PFs that can be used in a cell.

TABLE 2

| | Length | Payload | |
|---|---|---|---|
| PF | (symbols) | (bits) | Description |
| 0 | 1-2 | ≤2 | Short PUCCH with UE multiplexing in a PRB |
| 1 | 4-14 | ≤2 | Long PUCCH with UE multiplexing in a PRB |
| 2 | 1-2 | >2 | Short PUCCH with no UE multiplexing in a |
| | | | PRB |
| 3 | 4-14 | >2 | Long PUCCH, no UE multiplexing, large |
| | | | payload |
| 4 | 4-14 | >2 | Long PUCCH, some multiplexing, medium |
| | | | payload |

PF0 or PF1 is typically used for scheduling requests (SR) and/or HARQ of up to two (2) bits. For example, PF1 with one PRB over 14 symbols can typically support up to 36 UEs. PF2, PF3, or PF4 is typically used for larger HARQ feedback, buffer status reports (BSR), and CSI feedback. PF0 and PF2 are often used in high-band radio spectrum (FR2) while PF1, PF3, and PF4 are often used in low-to-mid-band radio spectrum (FR1). The following discussion will refer to PF1 and PF3 but it should be understood that PF4 can be substituted for PF3, or that both PF0 and PF2 can be substituted for PF1 and PF3.

FIG. 6 shows two exemplary partitionings of UL resources for a cell. Here the UL resources are N PRBs numbered 0 to N-1 that are sequential in frequency, with PRBs 0 and N-1 located at the minimum and maximum frequencies, respectively. In the left portioning, the two lowest-frequency and the two highest-frequency PRBs are allocated as PUCCH while all the intermediate PRBs are allocated as PUSCH. In the right partitioning, a group of 6n PRBs are allocated for n PRACH (i.e., 6 PRBs per PRACH) adjacent to the lower-frequency PUCCH PRBs, with the remaining intermediate PRBs being allocated as PUSCH.

UL resource partitioning is conventionally done at cell setup based on maximum expected values of various traffic metrics. For example, PUCCH resources for HARQ feedback and SR are dimensioned during cell setup, and each UE can be configured with a portion of such resources via RRC signaling. More specifically, each UE can be configured with up to 32 PF1 resources for HARQ feedback and up to 32 PF3 resources for each additional HARQ feedback set. Each UE can also be configured with one or more PUCCH resources that provide periodic occasions to send SRs.

When eight (8) or fewer PUCCH resources are configured, the gNB can then indicate via a three-bit field in DCI which configured PUCCH resource a UE should use for HARQ feedback. When 9-32 PUCCH resources are configured, the UE must also use the DCI's PDCCH position to identify which configured PUCCH resource should be use for HARQ feedback.

At cell setup, the network node serving the cell (or some other network function, such as OAM) can partition UL resources between PUSCH and PUCCH allocate PUCCH resources between PFs based on various factors, including one or more of the following:
Desired maximum number of RRC_CONNECTED UEs in the cell, with each UE requiring at least one periodic PF1 resource to send SRs. The number of needed PF1 resources is generally proportional to the number of RRC_CONNECTED UEs. If the number of UEs is greater than available SR resources, then those excess UEs will have to use PRACH to request SR resources, which is very resource intensive.
Cell DL-UL TDD pattern-in DL-heavy cells, UEs will need to report HARQ feedback for a greater number of DL slots in a smaller number of UL slots. This increases the number of HARQ feedback bits per slot, which increases the need for the larger PF3.
Number of users receiving DL data at the same DL slot—With Multi-User MIMO, the network can schedule 4-8 DL transmissions concurrently using the same time/frequency resources but with spatial multiplexing. However, the receiving UEs need separate UL resources to send HARQ feedback for the respective DL transmissions. Scheduling DL data for multiple users on different time/frequency resources in a single slot can have the same effect.
Scheduling CSI reports and HARQ feedback-the network schedules a UE's HARQ feedback to be sent K1 slots after PDSCH reception and the UE's PUSCH transmissions to be sent K2 slots after the scheduling DCI. One further requirement is that K1≥K2. Thus, when a UE is scheduled to transmit a CSI report on PUSCH, the UE must wait until at least the next slot (due to K1≥K2) to transmit HARQ feedback. It is likely that the UE will receive more DL data while waiting, thereby requiring more HARQ feedback bits and thus a need for the larger PF3.
UEs utilizing CA in the cell—if a UE receive DL data on multiple carriers provided by the cell (e.g., PCell and one or more SCells), the UE must transmit separate HARQ feedback for each carrier. Regardless of how many SCells carry the DL data, the UE can only transmit the corresponding HARQ feedback on its PCell. This increases the size of each HARQ feedback by the UE and thus a need for the larger PF3.

Conventionally, once partitioned and/or configured in this manner, the UL resource configuration for the cell remains the same during operation. However, the number of RRC_CONNECTED UEs, the number of UEs employing CA, the number of concurrently scheduled users, etc. vary widely during operation of the cell. As such, the initial UL resource partition is often sub-optimal for current traffic conditions in the cell. For example, if UL resources are configured with the expectation of many RRC_CONNECTED users, more UL resources will be allocated to PUCCH and fewer to PUSCH for carrying UL data. When fewer RRC_CONNECTED UEs are present in the cell, the over-dimensioned PUCCH resources cannot be used by the present UEs to transmit UL data.

As another example, if more PUSCH resources are configured with the expectation of moderate UL data traffic, DL user traffic can become congested due to lack of PUCCH resources for sending HARQ feedback-even DL resources are still available. This issue can be more serious with CA because any of multiple DL carriers (e.g., PCell and SCell) can be used for DL data transmission, but a UE's feedback needs to be sent the PCell PUCCH.

As another example, if more PUCCH resources are configured with the expectation of busy DL data traffic, fewer UL resources are left for PUSCH to carry UL data. If there are few RRC_CONNECTED UEs or small data volumes per UE during a relatively quiet time, the configured PUCCH resources cannot be used and are wasted.

Accordingly, embodiments of the present disclosure provide flexible and efficient techniques whereby UL resources can be dynamically reassigned to PUSCH or PUCCH and/or reconfigured to a different PF based on currently prevailing traffic conditions in a cell. These dynamic UL resources can be in addition to UL resources that are statically assigned and/or configured as PUCCH or PUSCH. For example, a dynamic PRB can be allocated and/or configured as PUSCH or one of multiple PUCCH formats based on various traffic conditions relative to predefined thresholds.

As a more specific example, a dynamic PRB can be initially allocated to and/or configured as PUSCH, based on a default condition of a moderate number of RRC_CONNECTED UEs and moderate DL data traffic in the cell. When the number of RRC_CONNECTED UEs increases above a first threshold, the dynamic PRB can be reconfigured as a PUCCH PRB according to a first PUCCH format (e.g., PF1). On the other hand, when the number of RRC_CONNECTED UEs that meet at least one criteria associated with DL data increases above a second threshold, the dynamic PRB can be reconfigured as a PUCCH PRB according to a second PUCCH format (e.g., PF3 or PF4). Various other criteria and/or conditions can be used to reconfigure a dynamic PRB from the second PUCCH format to the first PUCCH format or as a PUSCH PRB, or from the first PUCCH format to the second PUCCH format or as a PUSCH PRB.

Embodiments of the present disclosure can provide various benefits and/or advantages, in addition to those discussed above. For example, based on flexible reconfiguration of dynamic UL resources, the available UL resources in a cell can be used more effectively based on actual capacity and traffic needs at any given time. This can reduce the amount of UL resources that are unusable in various traffic conditions, which increases cell capacity both in terms of number of supported users and amount of UL/DL data traffic. Moreover, embodiments can reduce complexity of initial cell planning and optimization since they facilitate dynamic re-optimization of UL resources according to prevailing needs.

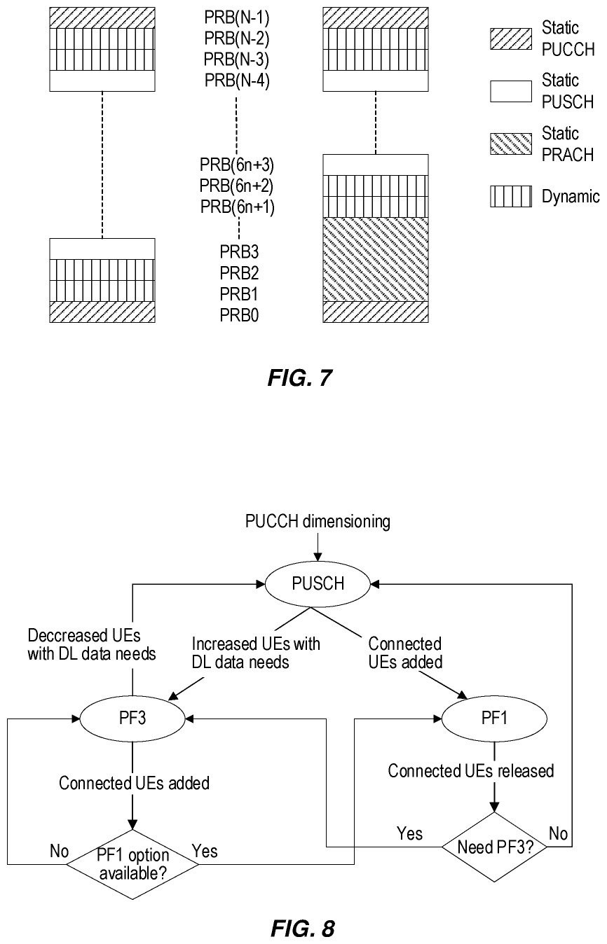

Embodiments will now be described in more detail based on various examples. FIG. 7 shows two exemplary partitionings of UL resources for a cell, according to various embodiments of the present disclosure. Similar to FIG. 6, the UL resources are N PRBs numbered 0 to N-1 that are sequential in frequency, with PRBs 0 and N-1 located at the minimum and maximum frequencies, respectively. For example, PRBs 0 to N-1 can constitute one BWP or multiple BWPs. The right partitioning is for a cell that includes PRACH resources while the left partitioning is for a cell that does not include PRACH resources.

Initially, a relatively small number of static PUCCH PRBs can be allocated and/or configured based on a default (or assumed) number of RRC_CONNECTED UEs and moderate DL data traffic. The static PUCCH PRBs can contain sufficient resources (i.e., PF1 for HARQ feedback and SRs, PF3 for HARQ feedback) to satisfy the default conditions. The static PUCCH PRBs are located at the edges of the cell frequency band. Two such static PUCCH PRBs are shown in FIG. 7.

Static PRACH PRBs can be configured as needed adjacent to the static PUCCH PRBs at the lower end of the cell frequency band. In the right partitioning of FIG. 7, a group of 6n PRBs are allocated for n PRACH (i.e., 6 PRBs per PRACH) adjacent to the lower-frequency static PUCCH PRB.

Additionally, one or more dynamic PRBs can be allocated adjacent to the higher-frequency static PUCCH PRB(s), and adjacent to the static PUCCH PRB(s) or static PRACH PRBs at the lower end of the cell frequency band. The dynamic PRBs can be dimensioned to meet highest expected requirements (e.g., during rush hour or occasional event) of number of RRC_CONNECTED UEs, number of UEs employing CA, multi-user concurrent DL data transmission, etc. The PUCCH resource formats and potential usages are pre-planned on these dynamic PRBs but not necessarily applied initially. Rather, these dynamic PRBs can be initially allocated and/or configured as PUSCH PRBs and reconfigured to PUCCH (e.g., as PF1 or PF3) as needed.

As shown in FIG. 7, any remaining PRBs in the mid-band between dynamic PRBs are allocated as static PUSCH PRBs. In some cases, it can be preferable to keep PUSCH PRBs contiguous for better UL data throughput performance.

As mentioned above, dynamic PRBs initially allocated and/or configured as PUSCH PRBs and reconfigured to PUCCH (e.g., as PF1 or PF3) as needed based on number of connected users and/or traffic demands. This is discussed in more detail below. A dynamic PRB configured as PF3, usable for HARQ feedback, can be indicated to RRC_CONNECTED UEs by the PUCCH resource indicator (PRI) that can be included in DCI format 1_0 and 1_1 with assignments of DL resources for receiving PDSCH transmissions. A dynamic PRB configured as PF1, usable for HARQ feedback, can be indicated to RRC_CONNECTED UEs by the PUCCH resource indicator (PRI) that can be included in DCI format 1_0 and 1_1 with assignments of DL resources for receiving PDSCH transmissions.

In general, there will be at least two PUCCH resource sets configured for HARQ feedback: a first set for PF1, which can only carry up to two HARQ bits; and a second set for PF3, which can carry more than two HARQ bits. More sets can be configured depending on actual needs. Upon receiving a DL resource assignment, a UE determines a corresponding PUCCH resource set based on the number of DL transmissions that the UE has received and their HARQ feedback to be sent in one UL slot. For example, assume a UE receives three DL transmissions with HARQ feedback to be sent in the same UL slot (i.e., 3 HARQ bits). When the UE receives the first two DL transmissions, it assumes that the first resource set for PF1 is to be used for the two feedback bits, but upon receiving the third DL transmission, the UE assumes that the second resource set for PF3 is to be used for three feedback bits. In this case, the UE interprets the received PRI as referring to the second resource set of PF3 resources.

The arrangement shown in FIG. 7 can be further illustrated by the following numerical example. Assume that one of the static PUCCH PRBs 0 and N-1 is configured as PF1, with some of this PRB providing HARQ feedback capacity and the remainder of this PRB providing SR capacity for 200 RRC_CONNECTED UEs (e.g., with desired SR periodicities and offsets). The other of static PUCCH PRBs 0 and N-1 is configured as PF3.

Dynamic PRBs 1 and N-2 are initially configured as PUSCH but can be reconfigured as PF1 or PF3. If configured as PF1, each can provide SR capacity for an additional 300 RRC_CONNECTED UEs (up to 800 UEs total). If not needed for PF1, either or both can be reconfigured as PF3. Dynamic PRBs 2 and N-3 are initially configured as PUSCH but can be reconfigured as PF3, i.e., an option for PF1 is not available for these PRBs. Accordingly, the initial PUSCH range is PRBs 1 to N-2.

Subsequently, the network node serving the cell (e.g., the gNB scheduler) tracks the number of RRC_CONNECTED UEs, the number of RRC_CONNECTED UEs operating in CA with pending DL data, and the usage of multi-user MIMO and/or spatial multiplexing to send DL data to multiple users in the same time and/or frequency resources. The network node can subsequently reconfigure one or more dynamic PRBs based on the relations of these statistics to various thresholds, discussed below.

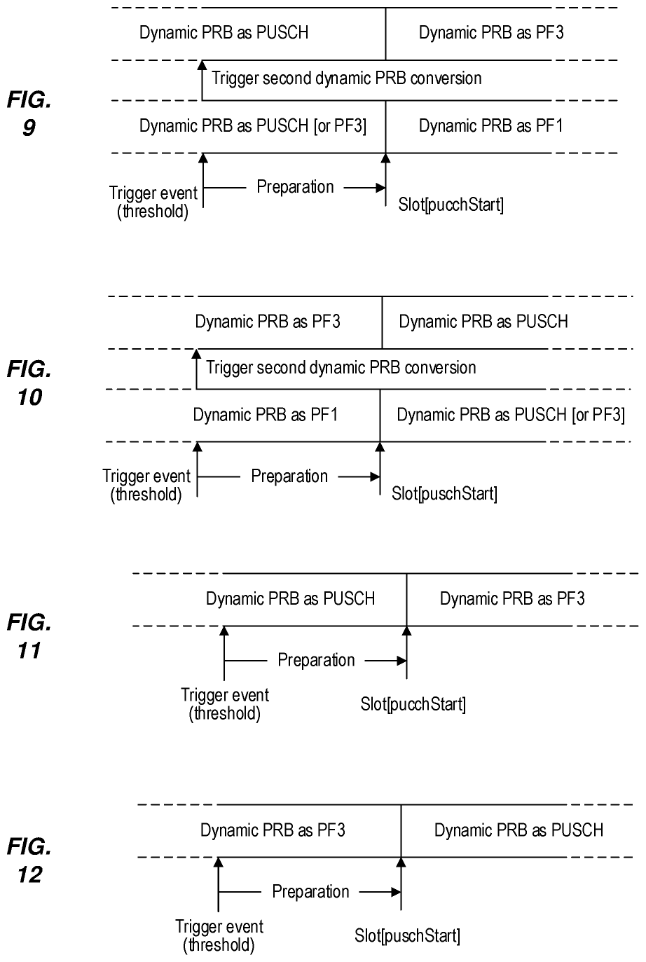

FIG. 8 shows an exemplary state transition diagram for a dynamic resource (e.g., PRB), according to various embodiments of the present disclosure. Initially, PUCCH dimensioning such as the example discussed above is used as a basis for configuring the resource as a dynamic resource (e.g., instead of static PUCCH or PUSCH) with an initial state as a PUSCH resource.

When the number of RRC_CONNECTED (or more simply, “connected”) UEs increases above a first threshold, the network node can reconfigure the dynamic resource as a PUCCH resource according to a first PUCCH format, e.g., PF1. For example, in the context of FIG. 7, when the number of connected UEs increases to close to (e.g., 90%) the SR capacity of the PRB (e.g., PRB N-1) configured as static PUCCH with PF1, the gNB scheduler prepares dynamic PRB1 (or PRB(6n+1), when PRACH is used) for reconfiguration from PUSCH to PF1.

FIG. 9 shows a timing diagram of a transition of a dynamic PRB from PUSCH or PF3 to PF1, according to various embodiments of the present disclosure. One assumption of this transition is at least one dynamic PRB is available to be converted to PF1. In some cases, this may be a dynamic PRB currently configured as PUSCH. In other cases, this may be a dynamic PRB currently configured as PF3. In these cases, another dynamic PRB currently configured as PUSCH can be reconfigured to PF3 to replace the dynamic PRB reconfigured from PF3 to PF1.

Initially, the network node finds the PRIs of the PF1 HARQ feedback mapped to the dynamic PRB and the set of potential SR resources with desired SR periods. If the dynamic PRB currently is configured as PUSCH, the network node identifies an UL slot (Slot_{pucchStart}) after the last UL slot in which UL data transmission has been scheduled on that PRB, with a safety margin if needed.

If the dynamic PRB currently is configured as PF3, the network node identifies an UL slot (Slot_{pucchStart}) after the last UL slot that has been scheduled or reserved for HARQ feedback, with a safety margin as needed, and refrains from further use the PRI associated with that PF3 for DL data scheduling. If a PF3 resource is needed to replace this reconfigured dynamic PRB, and there is a dynamic PRB currently used as PUSCH, the network node reconfigures that dynamic PRB from PUSCH to PF3. If multiple dynamic PRB candidates are available for reconfiguration, it can be preferable to select the one closest to a band edge.

In case two different Slot_{pucchStart} values were determined, the network node selects the later of the two, which will provide safe transitions for both dynamic PRBs (i.e., PF3 to PF1 and PUSCH to PF3). Based on the reconfigured dynamic PRB(s), the network node determines a new PUCCH resource range and corresponding PRIs. PRIs for this new PUCCH resource including the reconfigured dynamic PRB(s) can be provided with DL resource assignments for UL HARQ feedback in Slot_{pucchStart} and onward. Additionally, the network node selects proper offsets for SR resources in the dynamic PRB reconfigured as PF1 to occur after Slot_{pucchStart}.

As shown in FIG. 8, the number of connected UEs may decrease after the dynamic PRB has been reconfigured to PF1, such that no connected UEs are using the SR resources of that dynamic PRB. When the number of connected UEs using those SR resources decreases below a third threshold (e.g., 0-10% of capacity), the network node checks for available SR resources in other PRBs (either static or dynamic) configured as PF1. If enough resources are available to carry the small number of connected UEs remaining in the dynamic PRB, the network node can reconfigure the dynamic PRB and shift these remaining UEs to the PRB having the available resources. The network node can reconfigure the dynamic PRB to PF3 if additional PF3 resources are needed, e.g., based on the number of UEs connected to the cell that meet the at least one criteria being above a fourth threshold. Otherwise, the network node can reconfigure the dynamic PRB as a PUSCH resource.

FIG. 10 shows a timing diagram of a transition of a dynamic PRB from PF1 to PUSCH or PF3, according to various embodiments of the present disclosure. If the dynamic PRB is adjacent to the static PUSCH PRBs (e.g., PRB N-3 in FIG. 7), the network node may reconfigure it directly as a PUSCH PRB, thereby maintaining the contiguity of the PUSCH PRBs. However, if the dynamic PRB is not adjacent to the static PUSCH PRBs (e.g., PRB N-2 in FIG. 7) but there is another dynamic PRB (e.g., PRB N-3) adjacent that is currently configured as PF3, the network node can trigger a reconfiguration of the adjacent dynamic PRB to PUSCH and the non-adjacent dynamic PRB from PF1 to PF3, as shown in FIG. 10.

An exemplary procedure for these reconfigurations can be described as follows. Initially, the network node finds the PRIs that map to the dynamic PRB to be reconfigured from PF1. The network node identifies an UL slot (Slot_{puschStart}) after the last UL slot that has been scheduled or reserved for HARQ feedback (using PF1) in this dynamic PRB. The network node refrains from using PF1-related PRIs associated with that dynamic PRB for HARQ feedback at Slot_{puschStart} and thereafter but permits use of PF3-related PRIs associated with that dynamic PRB for HARQ feedback starting at Slot_{puschStart}.

For the adjacent dynamic PRB currently configured as PF3, the network node identifies an UL slot (Slot_{puschStart}) after the last UL slot that has been scheduled or reserved for HARQ feedback (using PF3) in this adjacent dynamic PRB. The network node refrains from using PF3-related PRIs associated with that dynamic PRB for HARQ feedback at Slot_{puschStart} and thereafter. The network node also determines the expanded PUSCH resource (including the reconfigured adjacent dynamic PRB) for use in UL resource grants at Slot_{puschStart} and thereafter.

Returning to FIG. 8, when the dynamic resource is initially configured as a PUSCH resource and the number of RRC_CONNECTED UEs that meet at least one criteria associated with DL data increases above a second threshold, the network node can reconfigure the dynamic resource as a PF3 resource. The at least one criteria can include a number of UEs operating in CA with pending DL data (e.g., via PCell and one or more SCells) and/or the usage of multi-user MIMO and/or spatial multiplexing to send DL data to multiple UEs in the same time and/or frequency resources.

In general, when an RRC_CONNECTED UE operating in CA user has large amount of DL data in buffered at the gNB, the UE and gNB will attempt to use the UE's active SCells (along with the PCell) to carry the DL data. Since a UE must provide separate HARQ feedback for each SCell, the use of CA in this manner with increase the need for PF3 resources for HARQ feedback. If there are more than a threshold number of CA users with relatively large amounts of buffered data (e.g., 5 users), the network node may determine that the static PUCCH resource configured as PF3 (which can serve only one UE per slot) is insufficient for this amount of CA-driven HARQ feedback. In other words, the limited static PUCCH resource may throttle the DL data capacity to these and other UEs operating in the cell. This can trigger the network node (e.g., gNB scheduler) to reconfigure a dynamic resource (e.g., PRB2 in FIG. 7) from PUSCH to PF3, which can alleviate the throttling. As the number of CA users increases, additional dynamic resources may need to be reconfigured from PUSCH to PF3 to maintain DL data capacity.

Similarly, when the gNB uses MIMO to send DL data to multiple UEs using the same time and/or frequency resources but with spatially multiplexed beams, each of those UEs will need separate PUCCH resources to provide HARQ feedback. If there are more than a threshold number (e.g., 4) users being multiplexed in this manner, the network node may determine that the static PUCCH resource configured as PF3 (which can serve only one UE per slot) is insufficient for this amount of MIMO-driven HARQ feedback. In other words, the limited static PUCCH resource may throttle the DL data capacity to these and other UEs operating in the cell. This can trigger the network node (e.g., gNB scheduler) to reconfigure a dynamic resource (e.g., PRB2 in FIG. 7) from PUSCH to PF3, which can alleviate the throttling. As the number of concurrent MIMO users increases, additional dynamic resources may need to be reconfigured from PUSCH to PF3 to maintain DL data capacity.

FIG. 11 shows a timing diagram of a transition of a dynamic PRB from PUSCH to PF3, according to various embodiments of the present disclosure. An exemplary procedure for these reconfigurations can be described as follows. Initially, the network node finds the PRIs that map to the dynamic PRB to be reconfigured as PF3. The network node identifies an UL slot (Slot_{pucchStart}) after the last UL slot in which UL data transmission has been scheduled on that PRB. with a safety margin if needed. The network node also determines the reduced PUSCH resource (excluding the reconfigured dynamic PRB) for use in UL resource grants at Slot_{pucchStart} and thereafter. The network node also permits use of PF3-related PRIs associated with the reconfigured dynamic PRB for HARQ feedback starting at Slot_{pucchStart}.

After the dynamic resource has been reconfigured as PF3, the number of connected UEs may increase. If this number is above some preconfigured fifth threshold (e.g., 90% of SR capacity of PUCCH resources currently configured as PF1), the network node may determine whether the dynamic resource should be reconfigured as PF1. Such reconfiguration as PF1 may not be an option for certain dynamic resources, such as dynamic PRBs 2 and N-3 shown in FIG. 7. In such case, the network node can refrain from reconfiguring the dynamic resource. In case PF1 option is available for the dynamic resource, the network node can perform this reconfiguration, thereby providing additional SR resources for the increased number of connected UEs. This reconfiguration can be done according to the procedure discussed above in relation to FIG. 9 (without the triggering of a second dynamic PRB conversion).

Alternately, after the dynamic resource has been reconfigured as PF3 and the number of RRC_CONNECTED UEs that meet the at least one criteria associated with DL data decreases below a sixth threshold, the network node can reconfigure the dynamic resource as a PUSCH resource. The sixth threshold can be the same or different than the second threshold discussed above.

FIG. 12 shows a timing diagram of a transition of a dynamic PRB from PF3 to PUSCH, according to various embodiments of the present disclosure. An exemplary procedure for this transition can be described as follows. Initially, the identifies an UL slot (Slot_{puschStart}) after the last UL slot that has been scheduled or reserved for HARQ feedback using the dynamic PRB as PF3, with a safety margin as needed. The network node also determines the expanded PUSCH resource (including the reconfigured dynamic PRB) for use in UL resource grants at Slot_{puschStart} and thereafter.

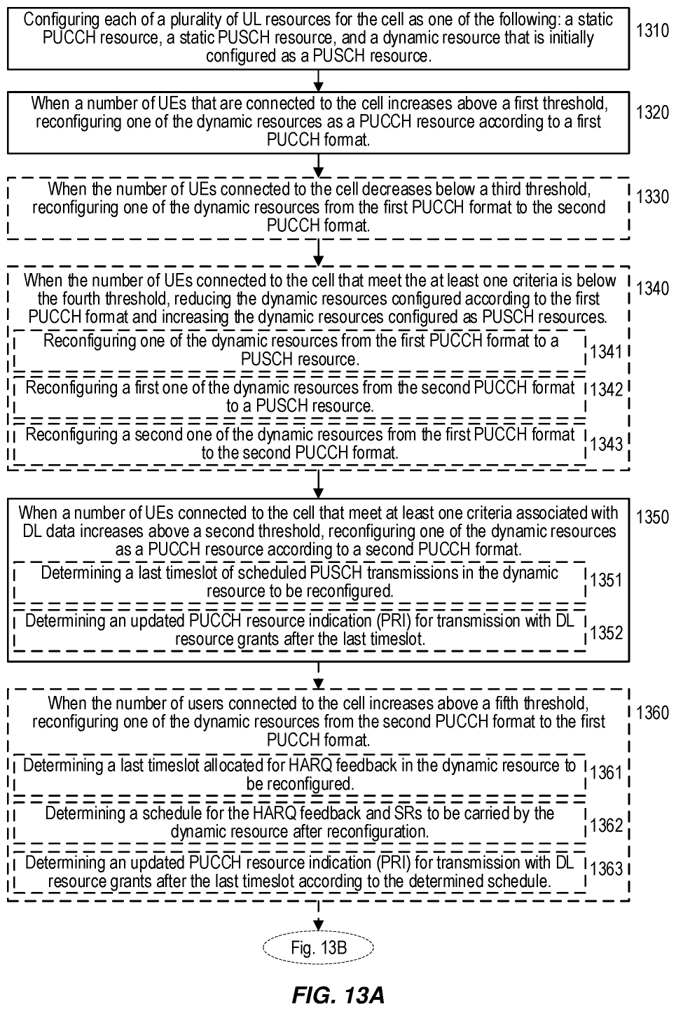

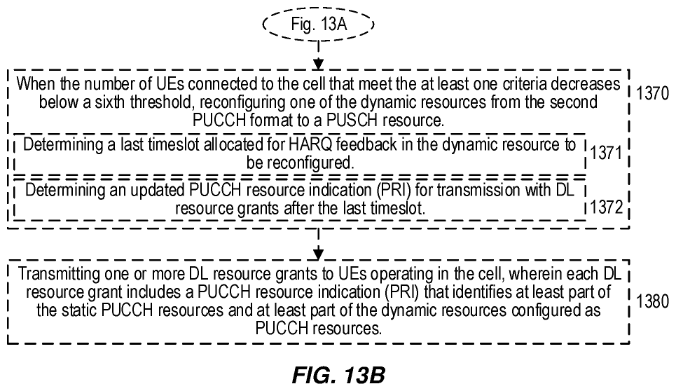

Various features of the embodiments described above correspond to various operations illustrated in FIGS. 13A-B, which shows an exemplary method (e.g., procedures) for configuring uplink (UL) resources for a cell of a wireless network. In other words, various features of the operations described below correspond to various embodiments described above. The exemplary method can be performed by a network node (e.g., base station, gNB, ng-eNB, etc. or components thereof) in the wireless network (e.g., NG-RAN, E-UTRAN), such as a network node described elsewhere herein.

Also, the exemplary method shown in FIGS. 13A-B can be performed cooperatively with other exemplary methods and/or procedures described herein, such as in relation to any of FIGS. 8-12. Although FIGS. 13A-B shows specific blocks in a particular order, the operations of the exemplary method can be performed in a different order than shown and can be combined and/or divided into blocks having different functionality than shown. Optional blocks or operations are indicated by dashed lines.

The exemplary method can include the operations of block 1310, where the network node can configure each of a plurality of UL resources for the cell as one of the following: a static physical UL control channel (PUCCH) resource, a static physical UL shared channel (PUSCH) resource, or a dynamic resource, being initially configured as a PUSCH resource. The exemplary method can also include the operations of block 1320, where when a number of user equipment (UEs) that are connected to the cell increases above a first threshold, the network node can reconfigure one of the dynamic resources as a PUCCH resource according to a first PUCCH format. The exemplary method can also include the operations of block 1350, where when a number of UEs connected to the cell that meet at least one criteria associated with downlink (DL) data increases above a second threshold, the network node can reconfigure one of the dynamic resources as a PUCCH resource according to a second PUCCH format.

In some embodiments, each of the plurality of UL resources for the cell is a physical resource block (PRB). In some embodiments, the first PUCCH format is PUCCH Format 1 (PF1) and the second PUCCH format is either PUCCH Format 3 (PF3) or PUCCH Format 4 (PF4), as specified by 3GPP. In some embodiments, the at least one criteria associated with DL data includes one or more of the following: operating in CA with pending DL data; and receiving DL data over the same time resources and/or the same frequency resources via spatial multiplexing.

In some embodiments, the UL resources for the cell can also include static PRACH resources. An example of these embodiments is shown in the right-side arrangement of FIG. 7.

In some embodiments, a first subset of the dynamic resources can have either the first PUCCH format or the second PUCCH format (e.g., PF1 or PF3), while a second subset of the dynamic resources can have the second PUCCH format but not the first PUCCH format. In some of these embodiments, the first subset is adjacent in frequency to static PUCCH resources.

In some embodiments, the exemplary method can also include the operations of block 1330, where the network node can, when the number of UEs connected to the cell decreases below a third threshold, reconfigure one of the dynamic resources from the first PUCCH format to the second PUCCH format. In some of these embodiments, reconfiguring one of the dynamic resources from the first PUCCH format to the second PUCCH format can be further based on the number of UEs connected to the cell that meet the at least one criteria being above a fourth threshold. In such embodiments, the exemplary method can also include the operations of block 1340, where the network node can, when the number of UEs connected to the cell that meet the at least one criteria is below the fourth threshold, reduce the dynamic resources configured according to the first PUCCH format and increase the dynamic resources configured as PUSCH resources.

In some variants, reducing the dynamic resources configured according to the first PUCCH format and increasing the dynamic resources configured as PUSCH resources in block 1340 can include the operations of sub-block 1341, where the network node can reconfigure one of the dynamic resources from the first PUCCH format (e.g., PF1) to a PUSCH resource.

In other variants, reducing the dynamic resources configured according to the first PUCCH format and increasing the dynamic resources configured as PUSCH resources in block 1340 can include the operations of sub-blocks 1342-1343, where the network node can reconfigure a first one of the dynamic resources from the second PUCCH format to a PUSCH resource and reconfigure a second one of the dynamic resources from the first PUCCH format to the second PUCCH format. For example, the first one of the dynamic resources is adjacent in frequency to a static PUSCH resource and the second one of the dynamic resources is not adjacent in frequency to any of the static PUSCH resources.

In some embodiments, the exemplary method can also include the operations of block 1360, where the network node can, when the number of users connected to the cell increases above a fifth threshold, reconfigure one of the dynamic resources from the second PUCCH format to the first PUCCH format. In some of these embodiments, the dynamic resource reconfigured from the second PUCCH format to the first PUCCH format can be adjacent in frequency to a static PUCCH resource.

In some of these embodiments, reconfiguring one of the dynamic resources from the second PUCCH format to the first PUCCH format in block 1360 can include the operations of sub-blocks 1361-1363. In sub-block 1361, the network node can determine a last timeslot allocated for hybrid ARQ (HARQ) feedback in the dynamic resource to be reconfigured. In sub-block 1362, the network node can determining a schedule for the HARQ feedback and scheduling requests (SR) to be carried by the dynamic resource after reconfiguration. In sub-block 1363, the network node can determine an updated PRI for transmission with DL resource grants after the last timeslot according to the determined schedule. The updated PRI identifies the dynamic resources configured as PUCCH resources according to the second PUCCH format, including the dynamic resource to be reconfigured.

In some embodiments, the exemplary method can also include the operations of block 1370, where the network node can, when the number of UEs connected to the cell that meet the at least one criteria decreases below a sixth threshold, reconfigure one of the dynamic resources from the second PUCCH format to a PUSCH resource. In some of these embodiments, the operations of block 1370 can include the operations of sub-blocks 1371-1372, where the network node can determine a last timeslot allocated for hybrid ARQ (HARQ) feedback in the dynamic resource to be reconfigured and determine an updated PRI for transmission with DL resource grants after the last timeslot. The updated PRI identifies the dynamic resources configured as PUCCH resources according to one of the first PUCCH format and the second PUCCH format, excluding the dynamic resource to be reconfigured.

In some embodiments, the exemplary method can also include the operations of block 1380, where the network node can transmit one or more DL resource grants to UEs operating in the cell, wherein each DL resource grant includes a PRI that identifies at least part of the static PUCCH resources and at least part of the dynamic resources configured as PUCCH resources. These embodiments can be applicable to the scenario where the network node includes communication circuitry (e.g., transmitters) that are capable of such transmission. In other embodiments, the network node may not include such communication circuitry, which may be located instead at a remote radio unit, distributed unit, etc.

In some of these embodiments, each transmitted PRI identifies one of the following:
portions of the static PUCCH resources and the dynamic resources that are configured according to the first PUCCH format; or
portions of the static PUCCH resources and the dynamic resources that are configured according to the second PUCCH format.

Although various embodiments are described above in terms of methods, techniques, and/or procedures, the person of ordinary skill will readily comprehend that such methods, techniques, and/or procedures can be embodied by various combinations of hardware and software in various systems, communication devices, computing devices, control devices, apparatuses, non-transitory computer-readable media, computer program products, etc.

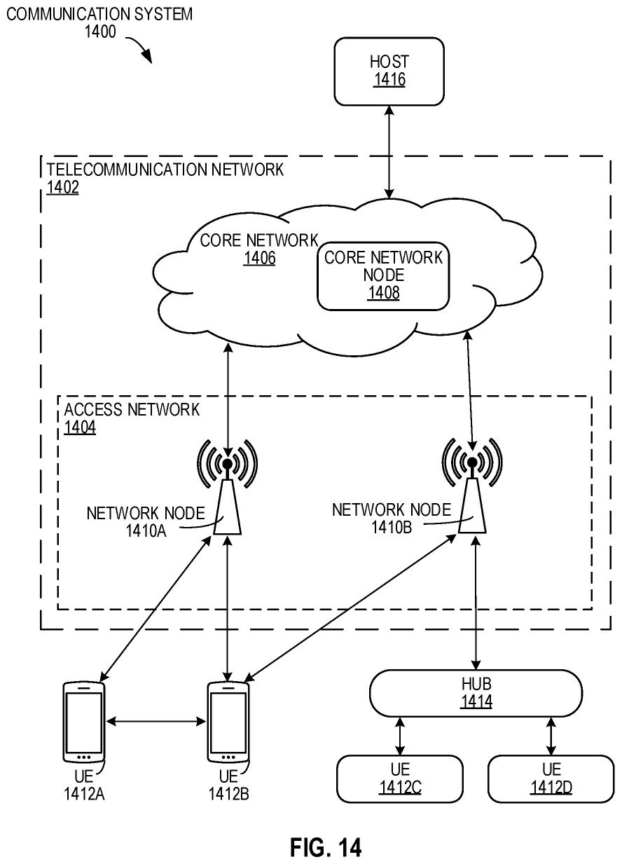

FIG. 14 shows an example of a communication system 1400 in accordance with some embodiments. In the example, the communication system 1400 includes a telecommunication network 1402 that includes an access network 1404, such as a radio access network (RAN), and a core network 1406, which includes one or more core network nodes 1408. The access network 1404 includes one or more access network nodes, such as network nodes 1410a and 1410b (one or more of which may be generally referred to as network nodes 1410), or any other similar 3^{rd} Generation Partnership Project (3GPP) access node or non-3GPP access point. The network nodes 1410 facilitate direct or indirect connection of user equipment (UE), such as by connecting UEs 1412a, 1412b, 1412c, and 1412d (one or more of which may be generally referred to as UEs 1412) to the core network 1406 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1400 may include any number of wired or wireless networks, network nodes, UEs, and/or any other components or systems that may facilitate or participate in the communication of data and/or signals whether via wired or wireless connections. The communication system 1400 may include and/or interface with any type of communication, telecommunication, data, cellular, radio network, and/or other similar type of system.

The UEs 1412 may be any of a wide variety of communication devices, including wireless devices arranged, configured, and/or operable to communicate wirelessly with the network nodes 1410 and other communication devices. Similarly, the network nodes 1410 are arranged, capable, configured, and/or operable to communicate directly or indirectly with the UEs 1412 and/or with other network nodes or equipment in the telecommunication network 1402 to enable and/or provide network access, such as wireless network access, and/or to perform other functions, such as administration in the telecommunication network 1402.

In the depicted example, the core network 1406 connects the network nodes 1410 to one or more hosts, such as host 1416. These connections may be direct or indirect via one or more intermediary networks or devices. In other examples, network nodes may be directly coupled to hosts. The core network 1406 includes one more core network nodes (e.g., core network node 1408) that are structured with hardware and software components. Features of these components may be substantially similar to those described with respect to the UEs, network nodes, and/or hosts, such that the descriptions thereof are generally applicable to the corresponding components of the core network node 1408. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1416 may be under the ownership or control of a service provider other than an operator or provider of the access network 1404 and/or the telecommunication network 1402, and may be operated by the service provider or on behalf of the service provider. The host 1416 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1400 of FIG. 14 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1402 is a cellular network that implements 3GPP standardized features. Accordingly, the telecommunications network 1402 may support network slicing to provide different logical networks to different devices that are connected to the telecommunication network 1402. For example, the telecommunications network 1402 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1412 are configured to transmit and/or receive information without direct human interaction. For instance, a UE may be designed to transmit information to the access network 1404 on a predetermined schedule, when triggered by an internal or external event, or in response to requests from the access network 1404. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 1414 communicates with the access network 1404 to facilitate indirect communication between one or more UEs (e.g., UE 1412c and/or 1412d) and network nodes (e.g., network node 1410b). In some examples, the hub 1414 may be a controller, router, content source and analytics, or any of the other communication devices described herein regarding UEs. For example, the hub 1414 may be a broadband router enabling access to the core network 1406 for the UEs. As another example, the hub 1414 may be a controller that sends commands or instructions to one or more actuators in the UEs. Commands or instructions may be received from the UEs, network nodes 1410, or by executable code, script, process, or other instructions in the hub 1414. As another example, the hub 1414 may be a data collector that acts as temporary storage for UE data and, in some embodiments, may perform analysis or other processing of the data. As another example, the hub 1414 may be a content source. For example, for a UE that is a VR headset, display, loudspeaker or other media delivery device, the hub 1414 may retrieve VR assets, video, audio, or other media or data related to sensory information via a network node, which the hub 1414 then provides to the UE either directly, after performing local processing, and/or after adding additional local content. In still another example, the hub 1414 acts as a proxy server or orchestrator for the UEs, in particular in if one or more of the UEs are low energy IoT devices.

The hub 1414 may have a constant/persistent or intermittent connection to the network node 1410b. The hub 1414 may also allow for a different communication scheme and/or schedule between the hub 1414 and UEs (e.g., UE 1412c and/or 1412d), and between the hub 1414 and the core network 1406. In other examples, the hub 1414 is connected to the core network 1406 and/or one or more UEs via a wired connection. Moreover, the hub 1414 may be configured to connect to an M2M service provider over the access network 1404 and/or to another UE over a direct connection. In some scenarios, UEs may establish a wireless connection with the network nodes 1410 while still connected via the hub 1414 via a wired or wireless connection. In some embodiments, the hub 1414 may be a dedicated hub-that is, a hub whose primary function is to route communications to/from the UEs from/to the network node 1410b. In other embodiments, the hub 1414 may be a non-dedicated hub-that is, a device which is capable of operating to route communications between the UEs and network node 1410b, but which is additionally capable of operating as a communication start and/or end point for certain data channels.

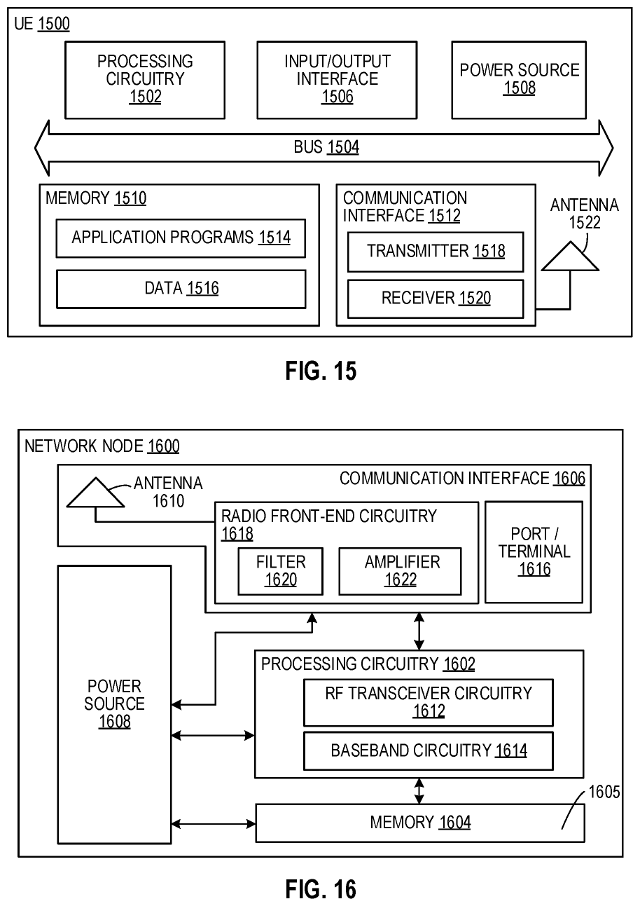

FIG. 15 shows a UE 1500 in accordance with some embodiments. As used herein, a UE refers to a device capable, configured, arranged and/or operable to communicate wirelessly with network nodes and/or other UEs. Examples of a UE include, but are not limited to, a smart phone. mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1500 includes processing circuitry 1502 that is operatively coupled via a bus 1504 to an input/output interface 1506, a power source 1508, a memory 1510, a communication interface 1512, and/or any other component, or any combination thereof. Certain UEs may utilize all or a subset of the components shown in FIG. 15. The level of integration between the components may vary from one UE to another UE. Further, certain UEs may contain multiple instances of a component, such as multiple processors, memories, transceivers, transmitters, receivers, etc.

The processing circuitry 1502 is configured to process instructions and data and may be configured to implement any sequential state machine operative to execute instructions stored as machine-readable computer programs in the memory 1510. The processing circuitry 1502 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1502 may include multiple central processing units (CPUs).

In the example, the input/output interface 1506 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1500. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1508 is structured as a battery or battery pack. Other types of power sources, such as an external power source (e.g., an electricity outlet), photovoltaic device, or power cell, may be used. The power source 1508 may further include power circuitry for delivering power from the power source 1508 itself, and/or an external power source, to the various parts of the UE 1500 via input circuitry or an interface such as an electrical power cable. Delivering power may be, for example, for charging of the power source 1508. Power circuitry may perform any formatting, converting, or other modification to the power from the power source 1508 to make the power suitable for the respective components of the UE 1500 to which power is supplied.

The memory 1510 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1510 includes one or more application programs 1514, such as an operating system, web browser application, a widget, gadget engine, or other application, and corresponding data 1516. The memory 1510 may store, for use by the UE 1500, any of a variety of various operating systems or combinations of operating systems.

The memory 1510 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1510 may allow the UE 1500 to access instructions, application programs and the like, stored on transitory or non-transitory memory media, to off-load data, or to upload data. An article of manufacture, such as one utilizing a communication system may be tangibly embodied as or in the memory 1510, which may be or comprise a device-readable storage medium.

The processing circuitry 1502 may be configured to communicate with an access network or other network using the communication interface 1512. The communication interface 1512 may comprise one or more communication subsystems and may include or be communicatively coupled to an antenna 1522. The communication interface 1512 may include one or more transceivers used to communicate, such as by communicating with one or more remote transceivers of another device capable of wireless communication (e.g., another UE or a network node in an access network). Each transceiver may include a transmitter 1518 and/or a receiver 1520 appropriate to provide network communications (e.g., optical, electrical, frequency allocations, and so forth). Moreover, the transmitter 1518 and receiver 1520 may be coupled to one or more antennas (e.g., antenna 1522) and may share circuit components, software or firmware, or alternatively be implemented separately.

In the illustrated embodiment, communication functions of the communication interface 1512 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1512, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1500 shown in FIG. 15.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 16 shows a network node 1600 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1600 includes a processing circuitry 1602, a memory 1604, a communication interface 1606, and a power source 1608. The network node 1600 may be composed of multiple physically separate components (e.g., a NodeB component and a RNC component, or a BTS component and a BSC component, etc.), which may each have their own respective components. In certain scenarios in which the network node 1600 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1600 may be configured to support multiple radio access technologies (RATs). In such embodiments, some components may be duplicated (e.g., separate memory 1604 for different RATs) and some components may be reused (e.g., a same antenna 1610 may be shared by different RATs). The network node 1600 may also include multiple sets of the various illustrated components for different wireless technologies integrated into network node 1600, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1600.

The processing circuitry 1602 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1600 components, such as the memory 1604, to provide network node 1600 functionality.

In some embodiments, the processing circuitry 1602 includes a system on a chip (SOC). In some embodiments, the processing circuitry 1602 includes one or more of radio frequency (RF) transceiver circuitry 1612 and baseband processing circuitry 1614. In some embodiments, the radio frequency (RF) transceiver circuitry 1612 and the baseband processing circuitry 1614 may be on separate chips (or sets of chips), boards, or units, such as radio units and digital units. In alternative embodiments, part or all of RF transceiver circuitry 1612 and baseband processing circuitry 1614 may be on the same chip or set of chips, boards, or units.

The memory 1604 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1602. The memory 1604 may store any suitable instructions, data, or information, including a computer program, software, an application including one or more of logic, rules, code, tables, and/or other instructions capable of being executed by the processing circuitry 1602 and utilized by the network node 1600. This information is collectively illustrated as computer program product 1605 in FIG. 16. The memory 1604 may also be used to store any calculations made by the processing circuitry 1602 and/or any data received via the communication interface 1606. In some embodiments, the processing circuitry 1602 and memory 1604 is integrated.

The communication interface 1606 is used in wired or wireless communication of signaling and/or data between a network node, access network, and/or UE. As illustrated, the communication interface 1606 comprises port(s)/terminal(s) 1616 to send and receive data, for example to and from a network over a wired connection. The communication interface 1606 also includes radio front-end circuitry 1618 that may be coupled to, or in certain embodiments a part of, the antenna 1610. Radio front-end circuitry 1618 comprises filters 1620 and amplifiers 1622. The radio front-end circuitry 1618 may be connected to an antenna 1610 and processing circuitry 1602. The radio front-end circuitry may be configured to condition signals communicated between antenna 1610 and processing circuitry 1602. The radio front-end circuitry 1618 may receive digital data that is to be sent out to other network nodes or UEs via a wireless connection. The radio front-end circuitry 1618 may convert the digital data into a radio signal having the appropriate channel and bandwidth parameters using a combination of filters 1620 and/or amplifiers 1622. The radio signal may then be transmitted via the antenna 1610. Similarly, when receiving data, the antenna 1610 may collect radio signals which are then converted into digital data by the radio front-end circuitry 1618. The digital data may be passed to the processing circuitry 1602. In other embodiments, the communication interface may comprise different components and/or different combinations of components.

In certain alternative embodiments, the network node 1600 does not include separate radio front-end circuitry 1618, instead, the processing circuitry 1602 includes radio front-end circuitry and is connected to the antenna 1610. Similarly, in some embodiments, all or some of the RF transceiver circuitry 1612 is part of the communication interface 1606. In still other embodiments, the communication interface 1606 includes one or more ports or terminals 1616, the radio front-end circuitry 1618, and the RF transceiver circuitry 1612, as part of a radio unit (not shown), and the communication interface 1606 communicates with the baseband processing circuitry 1614, which is part of a digital unit (not shown).

The antenna 1610 may include one or more antennas, or antenna arrays, configured to send and/or receive wireless signals. The antenna 1610 may be coupled to the radio front-end circuitry 1618 and may be any type of antenna capable of transmitting and receiving data and/or signals wirelessly. In certain embodiments, the antenna 1610 is separate from the network node 1600 and connectable to the network node 1600 through an interface or port.

The antenna 1610, communication interface 1606, and/or the processing circuitry 1602 may be configured to perform any receiving operations and/or certain obtaining operations described herein as being performed by the network node. Any information, data and/or signals may be received from a UE, another network node and/or any other network equipment. Similarly, the antenna 1610, the communication interface 1606, and/or the processing circuitry 1602 may be configured to perform any transmitting operations described herein as being performed by the network node. Any information, data and/or signals may be transmitted to a UE, another network node and/or any other network equipment.

The power source 1608 provides power to the various components of network node 1600 in a form suitable for the respective components (e.g., at a voltage and current level needed for each respective component). The power source 1608 may further comprise, or be coupled to, power management circuitry to supply the components of the network node 1600 with power for performing the functionality described herein. For example, the network node 1600 may be connectable to an external power source (e.g., the power grid, an electricity outlet) via an input circuitry or interface such as an electrical cable, whereby the external power source supplies power to power circuitry of the power source 1608. As a further example, the power source 1608 may comprise a source of power in the form of a battery or battery pack which is connected to, or integrated in, power circuitry. The battery may provide backup power should the external power source fail.

Embodiments of the network node 1600 may include additional components beyond those shown in FIG. 16 for providing certain aspects of the network node's functionality, including any of the functionality described herein and/or any functionality necessary to support the subject matter described herein. For example, the network node 1600 may include user interface equipment to allow input of information into the network node 1600 and to allow output of information from the network node 1600. This may allow a user to perform diagnostic, maintenance, repair, and other administrative functions for the network node 1600.

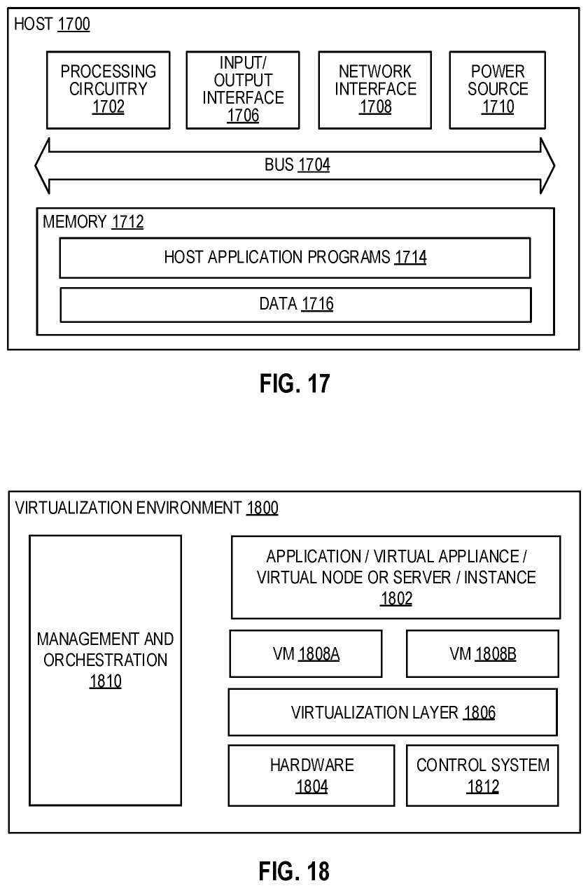

FIG. 17 is a block diagram of a host 1700, which may be an embodiment of the host 1416 of FIG. 14, in accordance with various aspects described herein. As used herein, the host 1700 may be or comprise various combinations hardware and/or software, including a standalone server, a blade server, a cloud-implemented server, a distributed server, a virtual machine, container, or processing resources in a server farm. The host 1700 may provide one or more services to one or more UEs.

The host 1700 includes processing circuitry 1702 that is operatively coupled via a bus 1704 to an input/output interface 1706, a network interface 1708, a power source 1710, and a memory 1712. Other components may be included in other embodiments. Features of these components may be substantially similar to those described with respect to the devices of previous figures, such as FIGS. 15 and 16, such that the descriptions thereof are generally applicable to the corresponding components of host 1700.

The memory 1712 may include one or more computer programs including one or more host application programs 1714 and data 1716, which may include user data, e.g., data generated by a UE for the host 1700 or data generated by the host 1700 for a UE. Embodiments of the host 1700 may utilize only a subset or all of the components shown. The host application programs 1714 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1714 may also provide for user authentication and licensing checks and may periodically report health, routes, and content availability to a central node, such as a device in or on the edge of a core network. Accordingly, the host 1700 may select and/or indicate a different host for over-the-top services for a UE. The host application programs 1714 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 18 is a block diagram illustrating a virtualization environment 1800 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1800 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1802 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1804 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1806 (also referred to as hypervisors or virtual machine monitors (VMMs)), provide VMs 1808a and 1808b (one or more of which may be generally referred to as VMs 1808), and/or perform any of the functions, features and/or benefits described in relation with some embodiments described herein. The virtualization layer 1806 may present a virtual operating platform that appears like networking hardware to the VMs 1808.

The VMs 1808 comprise virtual processing, virtual memory, virtual networking or interface and virtual storage, and may be run by a corresponding virtualization layer 1806. Different embodiments of the instance of a virtual appliance 1802 may be implemented on one or more of VMs 1808, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1808 may be a software implementation of a physical machine that runs programs as if they were executing on a physical, non-virtualized machine. Each of the VMs 1808, and that part of hardware 1804 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1808 on top of the hardware 1804 and corresponds to the application 1802.

Hardware 1804 may be implemented in a standalone network node with generic or specific components. Hardware 1804 may implement some functions via virtualization. Alternatively, hardware 1804 may be part of a larger cluster of hardware (e.g., such as in a data center or CPE) where many hardware nodes work together and are managed via management and orchestration 1810, which, among others, oversees lifecycle management of applications 1802. In some embodiments, hardware 1804 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1812 which may alternatively be used for communication between hardware nodes and radio units.

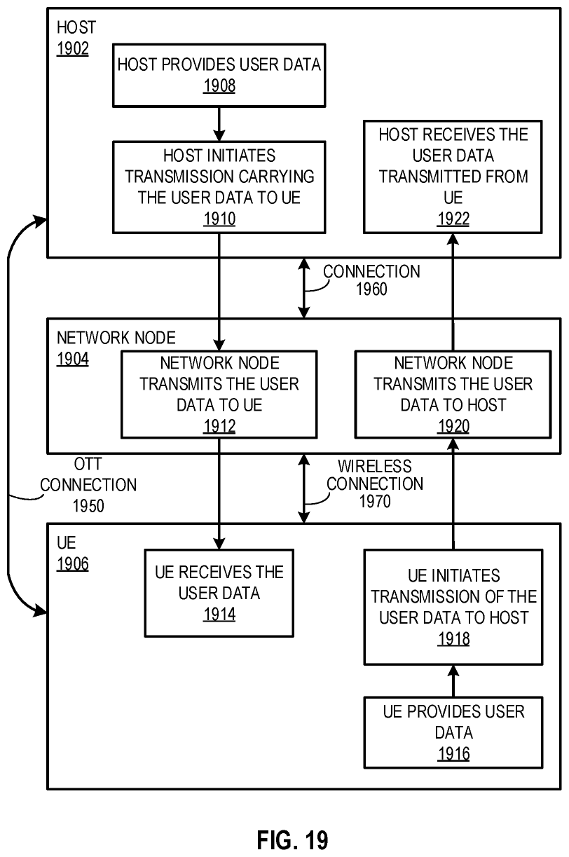

FIG. 19 shows a communication diagram of a host 1902 communicating via a network node 1904 with a UE 1906 over a partially wireless connection in accordance with some embodiments. Example implementations, in accordance with various embodiments, of the UE (such as a UE 1412a of FIG. 14 and/or UE 1500 of FIG. 15), network node (such as network node 1410a of FIG. 14 and/or network node 1600 of FIG. 16), and host (such as host 1416 of FIG. 14 and/or host 1700 of FIG. 17) discussed in the preceding paragraphs will now be described with reference to FIG. 19.

Like host 1700, embodiments of host 1902 include hardware, such as a communication interface, processing circuitry, and memory. The host 1902 also includes software, which is stored in or accessible by the host 1902 and executable by the processing circuitry. The software includes a host application that may be operable to provide a service to a remote user, such as the UE 1906 connecting via an over-the-top (OTT) connection 1950 extending between the UE 1906 and host 1902. In providing the service to the remote user, a host application may provide user data which is transmitted using the OTT connection 1950.

The network node 1904 includes hardware enabling it to communicate with the host 1902 and UE 1906. The connection 1960 may be direct or pass through a core network (like core network 1406 of FIG. 14) and/or one or more other intermediate networks, such as one or more public, private, or hosted networks. For example, an intermediate network may be a backbone network or the Internet.

The UE 1906 includes hardware and software, which is stored in or accessible by UE 1906 and executable by the UE's processing circuitry. The software includes a client application, such as a web browser or operator-specific “app” that may be operable to provide a service to a human or non-human user via UE 1906 with the support of the host 1902. In the host 1902, an executing host application may communicate with the executing client application via the OTT connection 1950 terminating at the UE 1906 and host 1902. In providing the service to the user, the UE's client application may receive request data from the host's host application and provide user data in response to the request data. The OTT connection 1950 may transfer both the request data and the user data. The UE's client application may interact with the user to generate the user data that it provides to the host application through the OTT connection 1950.

The OTT connection 1950 may extend via a connection 1960 between the host 1902 and the network node 1904 and via a wireless connection 1970 between the network node 1904 and the UE 1906 to provide the connection between the host 1902 and the UE 1906. The connection 1960 and wireless connection 1970, over which the OTT connection 1950 may be provided, have been drawn abstractly to illustrate the communication between the host 1902 and the UE 1906 via the network node 1904, without explicit reference to any intermediary devices and the precise routing of messages via these devices.

As an example of transmitting data via the OTT connection 1950, in step 1908, the host 1902 provides user data, which may be performed by executing a host application. In some embodiments, the user data is associated with a particular human user interacting with the UE 1906. In other embodiments, the user data is associated with a UE 1906 that shares data with the host 1902 without explicit human interaction. In step 1910, the host 1902 initiates a transmission carrying the user data towards the UE 1906. The host 1902 may initiate the transmission responsive to a request transmitted by the UE 1906. The request may be caused by human interaction with the UE 1906 or by operation of the client application executing on the UE 1906. The transmission may pass via the network node 1904, in accordance with the teachings of the embodiments described throughout this disclosure. Accordingly, in step 1912, the network node 1904 transmits to the UE 1906 the user data that was carried in the transmission that the host 1902 initiated, in accordance with the teachings of the embodiments described throughout this disclosure. In step 1914, the UE 1906 receives the user data carried in the transmission, which may be performed by a client application executed on the UE 1906 associated with the host application executed by the host 1902.

In some examples, the UE 1906 executes a client application which provides user data to the host 1902. The user data may be provided in reaction or response to the data received from the host 1902. Accordingly, in step 1916, the UE 1906 may provide user data, which may be performed by executing the client application. In providing the user data, the client application may further consider user input received from the user via an input/output interface of the UE 1906. Regardless of the specific manner in which the user data was provided, the UE 1906 initiates, in step 1918, transmission of the user data towards the host 1902 via the network node 1904. In step 1920, in accordance with the teachings of the embodiments described throughout this disclosure, the network node 1904 receives user data from the UE 1906 and initiates transmission of the received user data towards the host 1902. In step 1922, the host 1902 receives the user data carried in the transmission initiated by the UE 1906.

One or more of the various embodiments improve the performance of OTT services provided to the UE 1906 using the OTT connection 1950, in which the wireless connection 1970 forms the last segment. More precisely, embodiments of the present disclosure provide dynamic reconfiguration of UL resources in a cell between PUSCH and PUCCH, or between different PUCCH formats based on currently prevailing traffic conditions in a cell. Accordingly, the available UL resources in a cell can be used more effectively based on actual capacity and traffic needs at any given time. This can reduce the amount of UL resources that are unusable in various traffic conditions, which increases cell capacity both in terms of number of supported users and amount of UL/DL data traffic. This improves the performance of OTT services delivered via cells of a wireless network, which increases the value of such services to end-users and service providers.

In an example scenario, factory status information may be collected and analyzed by the host 1902. As another example, the host 1902 may process audio and video data which may have been retrieved from a UE for use in creating maps. As another example, the host 1902 may collect and analyze real-time data to assist in controlling vehicle congestion (e.g., controlling traffic lights). As another example, the host 1902 may store surveillance video uploaded by a UE. As another example, the host 1902 may store or control access to media content such as video, audio, VR or AR which it can broadcast, multicast or unicast to UEs. As other examples, the host 1902 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1950 between the host 1902 and UE 1906, in response to variations in the measurement results. The measurement procedure and/or the network functionality for reconfiguring the OTT connection may be implemented in software and hardware of the host 1902 and/or UE 1906. In some embodiments, sensors (not shown) may be deployed in or in association with other devices through which the OTT connection 1950 passes; the sensors may participate in the measurement procedure by supplying values of the monitored quantities exemplified above, or supplying values of other physical quantities from which software may compute or estimate the monitored quantities. The reconfiguring of the OTT connection 1950 may include message format, retransmission settings, preferred routing etc.; the reconfiguring need not directly alter the operation of the network node 1904. Such procedures and functionalities may be known and practiced in the art. In certain embodiments, measurements may involve proprietary UE signaling that facilitates measurements of throughput, propagation times, latency and the like, by the host 1902. The measurements may be implemented in that software causes messages to be transmitted, in particular empty or ‘dummy’ messages, using the OTT connection 1950 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various exemplary embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

1.-27. (canceled)

28. A method for configuring uplink (UL) resources for a cell of a wireless network, the method comprising:
configuring each of a plurality of UL resources for the cell as one of the following:
a static physical UL control channel (PUCCH) resource,
a static physical UL shared channel (PUSCH) resource, or
a dynamic resource, being initially configured as a PUSCH resource;
when a number of user equipment (UEs) that are connected to the cell increases above a first threshold, reconfiguring one of the dynamic resources as a PUCCH resource according to a first PUCCH format; and
when a number of UEs connected to the cell that meet at least one criteria associated with downlink (DL) data increases above a second threshold, reconfiguring one of the dynamic resources as a PUCCH resource according to a second PUCCH format.

29. The method of claim 28, wherein
a first subset of the dynamic resources can have either the first PUCCH format or the second PUCCH format; and
a second subset of the dynamic resources can have the second PUCCH format but not the first PUCCH format.

30. The method of claim 29, wherein the first subset is adjacent in frequency to static PUCCH resources.

31. The method of claim 28, further comprising, when the number of UEs connected to the cell decreases below a third threshold, reconfiguring one of the dynamic resources from the first PUCCH format to the second PUCCH format.

32. The method of claim 31, wherein:
reconfiguring one of the dynamic resources from the first PUCCH format to the second PUCCH format is further based on the number of UEs connected to the cell that meet the at least one criteria being above a fourth threshold; and
the method further comprises, when the number of UEs connected to the cell that meet the at least one criteria is below the fourth threshold, reducing the dynamic resources configured according to the first PUCCH format and increasing the dynamic resources configured as PUSCH resources.

33. The method of claim 32, wherein reducing the dynamic resources configured according to the first PUCCH format and increasing the dynamic resources configured as PUSCH resources comprises reconfiguring one of the dynamic resources from the first PUCCH format to a PUSCH resource.

34. The method of claim 32, wherein reducing the dynamic resources configured according to the first PUCCH format and increasing the dynamic resources configured as PUSCH resources comprises:
reconfiguring a first one of the dynamic resources from the second PUCCH format to a PUSCH resource; and
reconfiguring a second one of the dynamic resources from the first PUCCH format to the second PUCCH format.

35. The method of claim 34, wherein:
the first one of the dynamic resources is adjacent in frequency to a static PUSCH resource, and
the second one of the dynamic resources is not adjacent in frequency to any of the static PUSCH resources.

36. The method of claim 38, further comprising, when the number of users connected to the cell increases above a fifth threshold, reconfiguring one of the dynamic resources from the second PUCCH format to the first PUCCH format.

37. The method of claim 36, wherein the dynamic resource reconfigured from the second PUCCH format to the first PUCCH format is adjacent in frequency to a static PUCCH resource.

38. The method of claim 36, wherein reconfiguring one of the dynamic resources from the second PUCCH format to the first PUCCH format comprises:
determining a last timeslot allocated for hybrid ARQ (HARQ) feedback in the dynamic resource to be reconfigured;
determining a schedule for the HARQ feedback and scheduling requests (SR) to be carried by the dynamic resource after reconfiguration; and
determining an updated PUCCH resource indication (PRI) for transmission with DL resource grants after the last timeslot according to the determined schedule,
wherein the updated PRI identifies the dynamic resources configured as PUCCH resources according to the first PUCCH format, excluding the dynamic resource to be reconfigured.

39. The method of claim 28, wherein reconfiguring one of the dynamic resources as a PUCCH resource according to the second PUCCH format comprises:
determining a last timeslot of scheduled PUSCH transmissions in the dynamic resource to be reconfigured; and
determining an updated PUCCH resource indication (PRI) for transmission with DL resource grants after the last timeslot,
wherein the updated PRI identifies the dynamic resources configured as PUCCH resources according to the second PUCCH format, including the dynamic resource to be reconfigured.

40. The method of claim 28, further comprising, when the number of UEs connected to the cell that meet the at least one criteria decreases below a sixth threshold, reconfiguring one of the dynamic resources from the second PUCCH format to a PUSCH resource.

41. The method of claim 40, wherein reconfiguring one of the dynamic resources from the second PUCCH format to a PUSCH resource comprises:
determining a last timeslot allocated for hybrid ARQ (HARQ) feedback in the dynamic resource to be reconfigured; and
determining an updated PUCCH resource indication (PRI) for transmission with DL resource grants after the last timeslot,
wherein the updated PRI identifies the dynamic resources configured as PUCCH resources according to one of the first PUCCH format and the second PUCCH format, excluding the dynamic resource to be reconfigured.

42. The method of claim 28, wherein:
the first PUCCH format is PUCCH Format 1 (PF1) as specified by the Third-Generation Partnership Project (3GPP); and
the second PUCCH format is either PUCCH Format 3 (PF3) or PUCCH Format 4 (PF4), as specified by 3GPP.

43. The method of claim 28, wherein each of the plurality of UL resources for the cell is a physical resource block.

44. The method of claim 28, wherein the at least one criteria associated with DL data includes one or more of the following:
operating in carrier aggregation (CA) with pending DL data; and
receiving DL data over the same time resources and/or the same frequency resources via spatial multiplexing.

45. The method of claim 28, further comprising transmitting one or more DL resource grants to UEs operating in the cell, wherein each DL resource grant includes a PUCCH resource indication (PRI) that identifies at least part of the static PUCCH resources and at least part of the dynamic resources configured as PUCCH resources.

46. The method of claim 45, wherein each PRI included in a DL resource grant identifies one of the following:
portions of the static PUCCH resources and the dynamic resources that are configured according to the first PUCCH format; or
portions of the static PUCCH resources and the dynamic resources that are configured according to the second PUCCH format.

47. The method of claim 28, wherein the UL resources of the cell also include a plurality of static physical random access channel (PRACH) resources.

48. A network node arranged to configure uplink (UL) resources for a cell of a wireless network, the network node comprising:
processing circuitry operably coupled to communication circuitry arranged to transmit downlink (DL) transmissions and to receive uplink (UL) transmissions in the cell, wherein the processing circuitry is configured to:
configure each of a plurality of UL resources for the cell as one of the following:
a static physical UL control channel (PUCCH) resource,
a static physical UL shared channel (PUSCH) resource, and
a dynamic resource, being initially configured as a PUSCH resource;
when a number of user equipment (UEs) that are connected to the cell increases above a first threshold, reconfigure one of the dynamic resources as a PUCCH resource according to a first PUCCH format; and
when a number of UEs connected to the cell that meet at least one criteria associated with downlink (DL) data increases above a second threshold, reconfigure one of the dynamic resources as a PUCCH resource according to a second PUCCH format.

49. The network node of claim 48, further comprising the communication circuitry.

50. The network node of claim 48, wherein:
a first subset of the dynamic resources can have either the first PUCCH format or the second PUCCH format; and
a second subset of the dynamic resources can have the second PUCCH format but not the first PUCCH format.

51. The network node of claim 48, wherein the processing circuitry is further configured to reconfigure one of the dynamic resources from the first PUCCH format to the second PUCCH format, when the number of UEs connected to the cell decreases below a third threshold.

52. The network node of claim 51, wherein:
the processing circuitry is configured to reconfigure one of the dynamic resources from the first PUCCH format to the second PUCCH format further based on the number of UEs connected to the cell that meet the at least one criteria being above a fourth threshold; and
the processing circuitry is further configured to reduce the dynamic resources configured according to the first PUCCH format and increase the dynamic resources configured as PUSCH resources, when the number of UEs connected to the cell that meet the at least one criteria is below the fourth threshold.

53. The network node of claim 48, wherein the processing circuitry is configured to reconfigure one of the dynamic resources from the first PUCCH format to the second PUCCH format based on:
determining a last timeslot of scheduled PUSCH transmissions in the dynamic resource to be reconfigured; and
determining an updated PUCCH resource indication (PRI) for transmission with DL resource grants after the last timeslot,
wherein the updated PRI identifies the dynamic resources configured as PUCCH resources according to the second PUCCH format, including the dynamic resource to be reconfigured.

54. A non-transitory, computer-readable medium storing computer-executable instructions that, when executed by processing circuitry of a network node arranged to configure uplink (UL) resources for a cell of a wireless network. configure the network node to perform the method of claim 28.
